(19) United States
(12) Patent Application Publication
(10) Pub. No.: US 2003/0157470 A1
(43) Pub. Date: Aug. 21, 2003

(54) E-learning station and interface

(76) Inventors: Michael Altenhofen, Karlsruhe (DE); Joachim Schaper, Landau/Pfalz (DE); Wolfgang Gerteis, Karlsruhe (DE); Andreas S. Krebs, Karlsruhe (DE); Torsten Leidig, Karlsruhe (DE)

Correspondence Address: FISH & RICHARDSON, P.C., 3300 DAIN RAUSCHER PLAZA, 60 SOUTH SIXTH STREET, MINNEAPOLIS, MN, 55402, US

(21) Appl. No.: 10/196,718

(22) Filed: Jul. 17, 2002

Related U.S. Application Data
(63) Continuation-in-part of application No. 10/134,676, filed on Apr. 30, 2002.
(60) Provisional application No. 60/354,945, filed on Feb. 11, 2002.

(51) Int. Cl. G09B 3/00

(52) U.S. Cl. 434/350; 434/362; 434/118

(57) ABSTRACT

A learning system and a learning station for use with the learning system include an input to select a learning strategy and a course, a communications interface to transfer data between a learning management system and the learning station, and a processor to present a course based on the transferred data and the selected learning strategy. The learning station may include a learning interface to display course information and learner account information. The interface may include a navigation path window to suggest a navigation path based on the selected strategy.

This application claims priority from U.S. Application No. 10/134,676, filed Apr. 30, 2002, and titled E-LEARNING SYSTEM, and U.S. Provisional Application No. 60/354,945, filed Feb. 11, 2002, and titled FLEXIBLE INSTRUCTIONAL ARCHITECTURE FOR E-LEARNING, both of which are hereby incorporated by reference in their entirety for all purposes.

### TECHNICAL FIELD

The following description relates generally to e-learning and in particular to an e-learning station for e-learning courses.

### BACKGROUND

Systems and applications for delivering computer-based training (CBT) have existed for many years. However, CBT systems historically have not gained wide acceptance. A problem hindering the reception of CBTs as a means of training workers and learners is the compatibility between systems. A CBT system works as a stand-alone system that is unable to use content designed for use with other CBT systems.

Early CBTs also were based on hypermedia systems that statically linked content. User guidance was given by annotating the hyperlinks with descriptive information. The trainee could proceed through learning material by traversing the links embedded in the material. The structure associated with the material was very rigid, and the material could not be easily written, edited, or reused to create additional or new learning material.

Newer methods for intelligent tutoring and CBT systems are based on special domain models that must be defined prior to creation of the course or content. Once a course is created, the material may not be easily adapted or changed for different learners' specific training needs or learning styles. As a result, the courses often fail to meet the needs of the trainee and/or trainer.

The special domain models also have many complex rules that must be understood prior to designing a course. As a result, a course is too difficult for most authors to create who have not undergone extensive training in the use of the system. Even authors who receive sufficient training may find the system difficult and frustrating to use. In addition, the resulting courses may be incomprehensible due to incorrect use of the domain model by the authors creating the course. Therefore, for the above and other reasons, new methods and technology are needed to supplement traditional computer based training and instruction.

### SUMMARY

According to one general aspect, a learning system may include a learning station to take a course and select a learning strategy, a content management system to store the course including content and structure associated with the content, a learning management system to determine content to present to the learning station based on a learning strategy applied to the content and the structure, and a communications link to transfer the content from the learning management system to the learning station.

The course may include one or more structural elements including one or more of a course, a sub-course, a learning unit, and a knowledge item. The course and its structural elements do not enforce a sequence of structural elements that a learner must use to traverse the course.

The learning management system may include a content player configured to apply the selected learning strategy to the structural elements to determine a navigation path to be transmitted to the learning station. The content player may be configured to interpret metadata associated with the structural elements. The metadata may include attributes including one of a knowledge type and a competency.

The content player also may be configured to interpret relations between structural elements. The relations may be directional or non-directional.

The learning station may include a learning interface configured to present course information. The course information may include a learner account. The learner account may include training activities, course prebookings, a notebook, a qualifications profile, a profile matchup, and a preferred learning strategy.

The training activities may include courses that have been booked to the learner account. Prebookings may include courses desired by a learner but not offered by the learning system. The notebook may store one or more of learner qualifications, subject areas, courses, and course dates. The qualifications profile may include any qualifications that should be obtained by a learner. The qualifications profile may include any qualifications obtained by a learner. The profile matchup may be used to compare qualifications of a learner against a qualification profile.

The preferred learning strategy may be applied by the learning management system to the course structure to determine a navigation path for the content associated with the course.

The learning interface may include a messages and notes window to provide a learner with messages and notes from the learning administration system. The window may include mandatory courses a learner should take and qualifications the learner should obtain.

The learning interface also may include a current training activities window listing all courses booked by a learner.

The learning interface also may include a navigation window to access a course catalog listing all courses published to the administration management system.

The learning interface also may include a navigation window to access a search function to search for courses in the course catalog. The navigation window may be used to access a learner account. The learner account may include training activities, course prebookings, a notebook, a qualifications profile, a profile matchup, and a preferred learning strategy.

The learning interface may be configured to present course content to a learner. The learning interface may include a navigation bar to navigate through a course presented by the learning station. The navigation bar may include the functions back, continue, table of contents, and path.

The learning interface may include a navigation path window to display a navigation path to a learner. The content management system may include a content player and the content player may be configured to apply a learning strategy selected by a learner to the course content to determine the navigation path.

The applied learning strategy may be a macro-strategy. The macro-strategy may include applying one of a goal-based, top-down strategy, a goal-based, bottom-up strategy and a table of contents strategy. The applied learning strategy also may be a micro-strategy. The micro-strategy may include applying one of an orientation only strategy, an action oriented strategy, an explanation oriented strategy, an orientation oriented strategy, and a table of contents strategy. The applied learning strategy also may be a combination of a macro and a micro learning strategy.

Other features and advantages will be apparent from the description, the drawings, and the claims.

### DESCRIPTION OF DRAWINGS

FIG. 1 is an exemplary content aggregation model.

FIG. 2 is an example of an ontology of knowledge types.

FIG. 3 is an example of a course graph for e-learning.

FIG. 4 is an example of a sub-course graph for e-learning.

FIG. 5 is an example of a learning unit graph for e-learning.

FIGS. 6 and 7 are exemplary block diagrams of e-learning systems.

FIGS. 8-21 are exemplary screen shots of a learning interface.

FIG. 22 is an exemplary course.

FIGS. 23-27 an exemplary navigation paths.

FIG. 28 is an example showing v as the vertex that represents the learning unit LU where v₁,v₂ are the vertices.

Like reference symbols in the various drawings indicate like elements.

### DETAILED DESCRIPTION

E-learning Content Structure

The e-learning system and methodology structures content so that the content is reusable and flexible. For example, the content structure allows the creator of a course to reuse existing content to create new or additional courses. In addition, the content structure provides flexible content delivery that may be adapted to the learning styles of different learners.

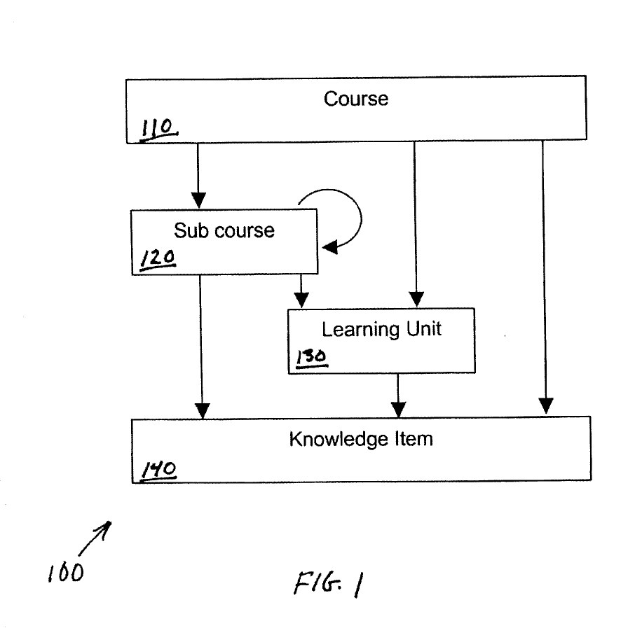

E-learning content may be aggregated using a number of structural elements arranged at different aggregation levels. Each higher level structural element may refer to any instances of all structural elements of a lower level. At its lowest level, a structural element refers to content and may not be further divided. According to one implementation shown in FIG. 1, course material 100 may be divided into four structural elements: a course 110, a sub-course 120, a learning unit 130, and a knowledge item 140.

Starting from the lowest level, knowledge items 140 are the basis for the other structural elements and are the building blocks of the course content structure. Each knowledge item 140 may include content that illustrates, explains, practices, or tests an aspect of a thematic area or topic. Knowledge items 140 typically are small in size (i.e., of short duration, e.g., approximately five minutes or less).

A number of attributes may be used to describe a knowledge item 140, such as, for example, a name, a type of media, and a type of knowledge. The name may be used by a learning system to identify and locate the content associated with a knowledge item 140. The type of media describes the form of the content that is associated with the knowledge item 140. For example, media types include a presentation type, a communication type, and an interactive type. A presentation media type may include a text, a table, an illustration, a graphic, an image, an animation, an audio clip, and a video clip. A communication media type may include a chat session, a group (e.g., a newsgroup, a team, a class, and a group of peers), an email, a short message service (SMS), and an instant message. An interactive media type may include a computer based training, a simulation, and a test.

A knowledge item 140 also may be described by the attribute of knowledge type. For example, knowledge types include knowledge of orientation, knowledge of action, knowledge of explanation, and knowledge of source/reference. Knowledge types may differ in learning goal and content. For example, knowledge of orientation offers a point of reference to the learner, and, therefore, provides general information for a better understanding of the structure of interrelated structural elements. Each of the knowledge types is described in further detail below.

Knowledge items 140 may be generated using a wide range of technologies, however, a browser (including plug-in applications) should be able to interpret and display the appropriate file formats associated with each knowledge item. For example, markup languages (such as a Hypertext Markup language (HTML), a standard generalized markup language (SGML), a dynamic HTML (DHTML), or an extensible markup language (XML)), JavaScript (a client-side scripting language), and/or Flash may be used to create knowledge items 140.

HTML may be used to describe the logical elements and presentation of a document, such as, for example, text, headings, paragraphs, lists, tables, or image references.

Flash may be used as a file format for Flash movies and as a plug-in for playing Flash files in a browser. For example, Flash movies using vector and bitmap graphics, animations, transparencies, transitions, MP3 audio files, input forms, and interactions may be used. In addition, Flash allows a pixel-precise positioning of graphical elements to generate impressive and interactive applications for presentation of course material to a learner.

Learning units 130 may be assembled using one or more knowledge items 140 to represent, for example, a distinct, thematically-coherent unit. Consequently, learning units 130 may be considered containers for knowledge items 140 of the same topic. Learning units 130 also may be considered relatively small in size (i.e., duration) though larger than a knowledge item 140.

Sub-courses 120 may be assembled using other sub-courses 120, learning units 130, and/or knowledge items 140. The sub-course 120 may be used to split up an extensive course into several smaller subordinate courses. Sub-courses 120 may be used to build an arbitrarily deep nested structure by referring to other sub-courses 120.

Courses may be assembled from all of the subordinate structural elements including sub-courses 120, learning units 130, and knowledge items 140. To foster maximum reuse, all structural elements should be self-contained and context free.

Structural elements also may be tagged with metadata that is used to support adaptive delivery, reusability, and search/retrieval of content associated with the structural elements. For example, learning object metadata (LOM) defined by the IEEE “Learning Object Metadata Working Group” may be attached to individual course structure elements. The metadata may be used to indicate learner competencies associated with the structural elements. Other metadata may include a number of knowledge types (e.g., orientation, action, explanation, and resources) that may be used to categorize structural elements.

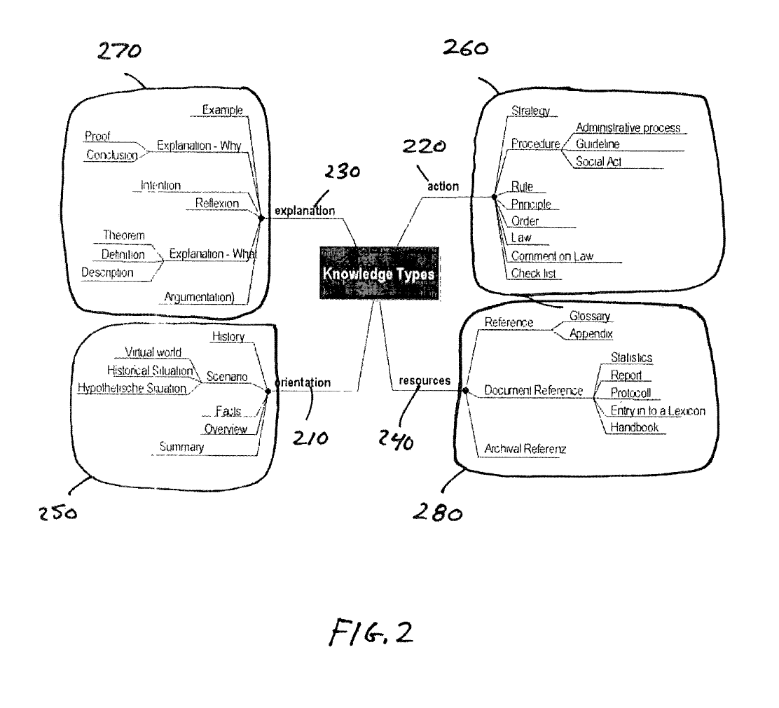

As shown in FIG. 2, structural elements may be categorized using a didactical ontology 200 of knowledge types 201 that includes orientation knowledge 210, action knowledge 220, explanation knowledge 230, and reference knowledge 240. Orientation knowledge 210 helps a learner to find their way through a topic without being able to act in a topic-specific manner and may be referred to as “know what.” Action knowledge 220 helps a learner to acquire topic related skills and may be referred to as “know how.” Explanation knowledge 230 provides a learner with an explanation of why something is the way it is and may be referred to as “know why.” Reference knowledge 240 teaches a learner where to find additional information on a specific topic and may be referred to as “know where.”

The four knowledge types (orientation, action, explanation, and reference) may be further divided into a fine grained ontology as shown in FIG. 2. For example, orientation knowledge 210 may refer to sub-types 250 that include a history, a scenario, a fact, an overview, and a summary. Action knowledge 220 may refer to sub-types 260 that include a strategy, a procedure, a rule, a principle, an order, a law, a comment on law, and a checklist. Explanation knowledge 230 may refer to sub-types 270 that include an example, a intention, a reflection, an explanation of why or what, and an argumentation. Resource knowledge 240 may refer to sub-types 280 that include a reference, a document reference, and an archival reference.

Dependencies between structural elements may be described by relations when assembling the structural elements at one aggregation level. A relation may be used to describe the natural, subject-taxonomic relation between the structural elements. A relation may be directional or non-directional. A directional relation may be used to indicate that the relation between structural elements is true only in one direction. Directional relations should be followed. Relations may be divided into two categories: subject-taxonomic and non-subject taxonomic.

Subject-taxonomic relations may be further divided into hierarchical relations and associative relations. Hierarchical relations may be used to express a relation between structural elements that have a relation of subordination or superordination. For example, a hierarchical relation between the knowledge items A and B exists if B is part of A. Hierarchical relations may be divided into two categories: the part/whole relation (i.e., “has part”) and the abstraction relation (i.e., “generalizes”). For example, the part/whole relation “A has part B,” describes that B is part of A. The abstraction relation “A generalizes B” implies that B is a specific type of A (e.g., an aircraft generalizes a jet or a jet is a specific type of aircraft).

Associative relations may be used refer to a kind of relation of relevancy between two structural elements. Associative relations may help a learner obtain a better understanding of facts associated with the structural elements. Associative relations describe a manifold relation between two structural elements and are mainly directional (i.e., the relation between structural elements is true only in one direction). Examples of associative relations include “determines,” “side-by-side,” “alternative to,” “opposite to,” “precedes,” “context of,” “process of,” “values,” “means of,” and “affinity.”

The “determines” relation describes a deterministic correlation between A and B (e.g., B causally depends on A). The “side-by-side” relation may be viewed from a spatial, conceptual, theoretical, or ontological perspective (e.g., A side-by-side with B is valid if both knowledge objects are part of a superordinate whole). The side-by-side relation may be subdivided into relations, such as “similar to” “alternative to,” and “analogous to.” The “opposite to” relation implies that two structural elements are opposite in reference to at least one quality. The “precedes” relation describes a temporal relationship of succession (e.g., A occurs in time before B (and not that A is a prerequisite of B)). The “context of” relation describes the factual and situational relationship on a basis of which one of the related structural elements may be derived. An “affinity” between structural elements suggests that there is a close functional correlation between the structural elements (e.g., there is an affinity between books and the act of reading because reading is the main function of books).

Non Subject-Taxonomic relations may include the relations “prerequisite of” and “belongs to.” The “prerequisite of” and the “belongs to” relations do not refer to the subject-taxonomic interrelations of the knowledge to be imparted. Instead, these relations refer to the progression of the course in the learning environment (e.g., as the learner traverses the course). The “prerequisite of” relation is directional whereas the “belongs to” relation is non-directional. Both relations may be used for knowledge items 140 that cannot be further subdivided. For example, if the size of the screen is too small to display the entire content on one page, the page displaying the content may be split into two pages that are connected by the relation “prerequisite of.”

Another type of metadata is competencies. Competencies may be assigned to structural elements, such as, for example, a sub-course 120 or a learning unit 130. The competencies may be used to indicate and evaluate the performance of a learner as the learner traverse the course material. A competency may be classified as a cognitive skill, an emotional skill, an senso-motorical skill, or a social skill.

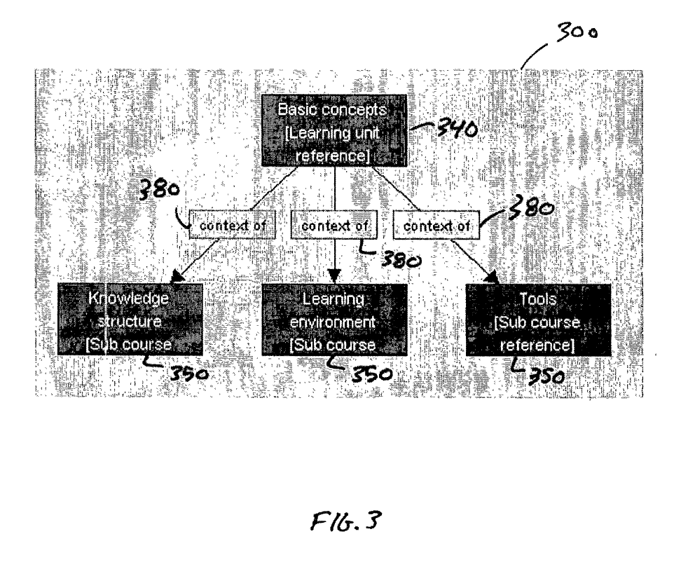

The content structure associated with a course may be represented as a set of graphs. A structural element may be represented as a node in a graph. Node attributes are used to convey the metadata attached to the corresponding structural element (e.g., a name, a knowledge type, a competency, and/or a media type). A relation between two structural elements may be represented as an edge. For example, FIG. 3 shows a graph 300 for a course. The course is divided into four structural elements or nodes (310, 320, 330, and 340): three sub-courses (e.g., knowledge structure, learning environment, and tools) and one learning unit (e.g., basic concepts). A node attribute 350 of each node is shown in brackets (e.g., the node labeled “Basic concepts” has an attribute that identifies it as a reference to a learning unit). In addition, an edge 380 expressing the relation “context of” has been specified for the learning unit with respect to each of the sub-courses. As a result, the basic concepts explained in the learning unit provide the context for the concepts covered in the three sub-courses.

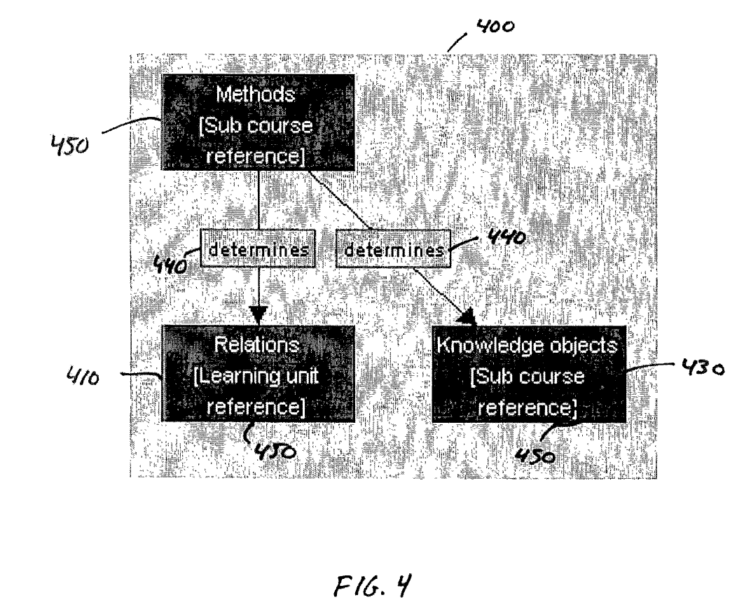

FIG. 4 shows a graph 400 of the sub-course “Knowledge structure” 350 of FIG. 3. In this example, the sub-course “Knowledge structure” is further divided into three nodes (410, 420, and 430): a learning unit (e.g., on relations) and two sub-courses (e.g., covering the topics of methods and knowledge objects). The edge 440 expressing the relation “determines” has been provided between the structural elements (e.g., the sub-course “Methods” determines the sub-course “Knowledge objects” and the learning unit “Relations”.) In addition, the attribute 450 of each node is shown in brackets (e.g., nodes “Methods” and “Knowledge objects” have the attribute identifying them as references to other sub-courses; node “Relations” has the attribute of being a reference to a learning unit).

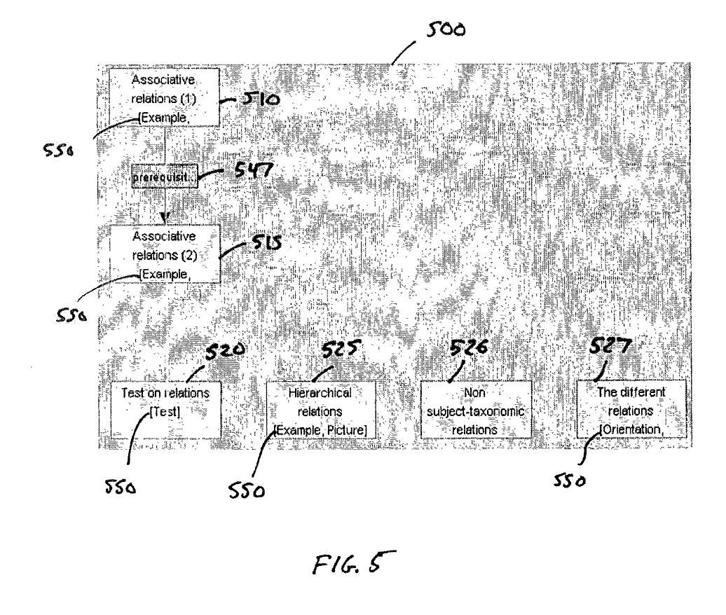

FIG. 5 shows a graph 500 for the learning unit “Relations” 450 shown in FIG. 4. The learning unit includes six nodes (510, 515, 520, 525, 530, 535, 540, and 545): six knowledge items (i.e., “Associative relations (1)”, “Associative relations (2)”, “Test on relations”, “Hierarchical relations”, “Non subject-taxonomic relations”, and “The different relations”). An edge 547 expressing the relation “prerequisite” has been provided between the knowledge items “Associative relations (1)” and “Associative relations (2).” In addition, attributes 550 of each node are specified in brackets (e.g., the node “Hierarchical relations” includes the attributes “Example” and “Picture”).

E-Learning Strategies

The above-described content aggregation and structure associated with a course does not automatically enforce any sequence that a learner may use to traverse the content associated with the course. As a result, different sequencing rules may be applied to the same course structure to provide different paths through the course. The sequencing rules applied to the knowledge structure of a course are learning strategies. The learning strategies may be used to pick specific structural elements to be suggested to the learner as the learner progresses through the course. The learner or supervisor (e.g., a tutor) may select from a number of different learning strategies while taking a course. In turn, the selected learning strategy considers both the requirements of the course structure and the preferences of the learner.

In the classical classroom, a teacher determines the learning strategy that is used to learn course material. For example, in this context the learning progression may start with a course orientation, followed by an explanation (with examples), an action, and practice. Using the e-learning system and methods, a learner may choose between one or more learning strategies to determine which path to take through the course. As a result, the progression of learners through the course may differ.

Learning strategies may be created using macro-strategies and micro-strategies. A learner may select from a number of different learning strategies when taking a course. The learning strategies are selected at run time of the presentation of course content to the learner (and not during the design of the knowledge structure of the course). As result, course authors are relieved from the burden of determining a sequence or an order of presentation of the course material. Instead, course authors may focus on structuring and annotating the course material. In addition, authors are not required to apply complex rules or Boolean expressions to domain models thus minimizing the training necessary to use the system. Furthermore, the course material may be easily adapted and reused to edit and create new courses.

Macro-strategies are used in learning strategies to refer to the coarse-grained structure of a course (i.e., the organization of sub-courses 120 and learning units 130). The macro-strategy determines the sequence that sub-courses 120 and learning units 130 of a course are presented to the learner. Basic macro-strategies include “inductive” and “deductive,” which allow the learner to work through the course from the general to the specific or the specific to the general, respectively. Other examples of macro-strategies include “goal-based, top-down,” “goal-based, bottom-up,” and “table of contents.”

Goal-based, top-down follows a deductive approach. The structural hierarchies are traversed from top to bottom. Relations within one structural element are ignored if the relation does not specify a hierarchical dependency. Goal-based bottom-up follows an inductive approach by doing a depth first traversal of the course material. The table of contents simply ignores all relations.

Micro-strategies, implemented by the learning strategies, target the learning progression within a learning unit. The micro-strategies determine the order that knowledge items of a learning unit are presented. Micro-strategies refer to the attributes describing the knowledge items. Examples of micro-strategies include “orientation only”, “action oriented”, “explanation-oriented”, and “table of contents”).

The micro-strategy “orientation only” ignores all knowledge items that are not classified as orientation knowledge. The “orientation only” strategy may be best suited to implement an overview of the course. The micro-strategy “action oriented” first picks knowledge items that are classified as action knowledge. All other knowledge items are sorted in their natural order (i.e., as they appear in the knowledge structure of the learning unit). The micro-strategy “explanation oriented” is similar to action oriented and focuses on explanation knowledge. Orientation oriented is similar to action oriented and focuses on orientation knowledge. The micro-strategy “table of contents” operates like the macro-strategy table of contents (but on a learning unit level).

In one implementation, no dependencies between macro-strategies and micro-strategies exist. Therefore, any combination of macro and micro-strategies may be used when taking a course. Application of learning strategies to the knowledge structure of a course is described in further detail below.

E-Learning System

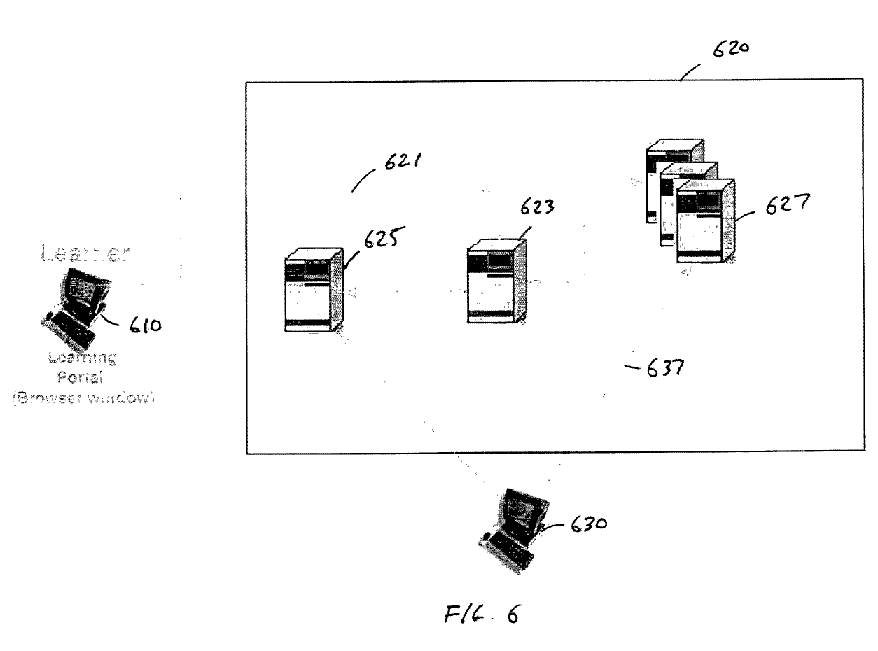

As shown in FIG. 6 an e-learning architecture 600 may include a learning station 610 and a learning system 620. The learner may access course material using a learning station 610 (e.g., using a learning portal). The learning station 610 may be implemented using a work station, a computer, a portable computing device, or any intelligent device capable of executing instructions and connecting to a network. The learning station 610 may include any number of devices and/or peripherals (e.g., displays, memory/storage devices, input devices, interfaces, printers, communication cards, and speakers) that facilitate access to and use of course material.

The learning station 610 may execute any number of software applications, including an application that is configured to access, interpret, and present courses and related information to a learner. The software may be implemented using a browser, such as, for example, Netscape communicator, Microsoft's Internet explorer, or any other software application that may be used to interpret and process a markup language, such as HTML, SGML, DHTML, or XML.

The browser also may include software plug-in applications that allow the browser to interpret, process, and present different types of information. The browser may include any number of application tools, such as, for example, Java, Active X, JavaScript, and Flash.

The browser may be used to implement a learning portal that allows a learner to access the learning system 620. A link 621 between the learning portal and the learning system 620 may be configured to send and receive signals (e.g., electrical, electromagnetic, or optical). In addition, the link may be a wireless link that uses electromagnetic signals (e.g., radio, infrared, to microwave) to convey information between the learning station and the learning system.

The learning system may include one or more servers. As shown in FIG. 6, the learning system 620 includes a learning management system 623, a content management system 625, and an administration management system 627. Each of these systems may be implemented using one or more servers, processors, or intelligent network devices.

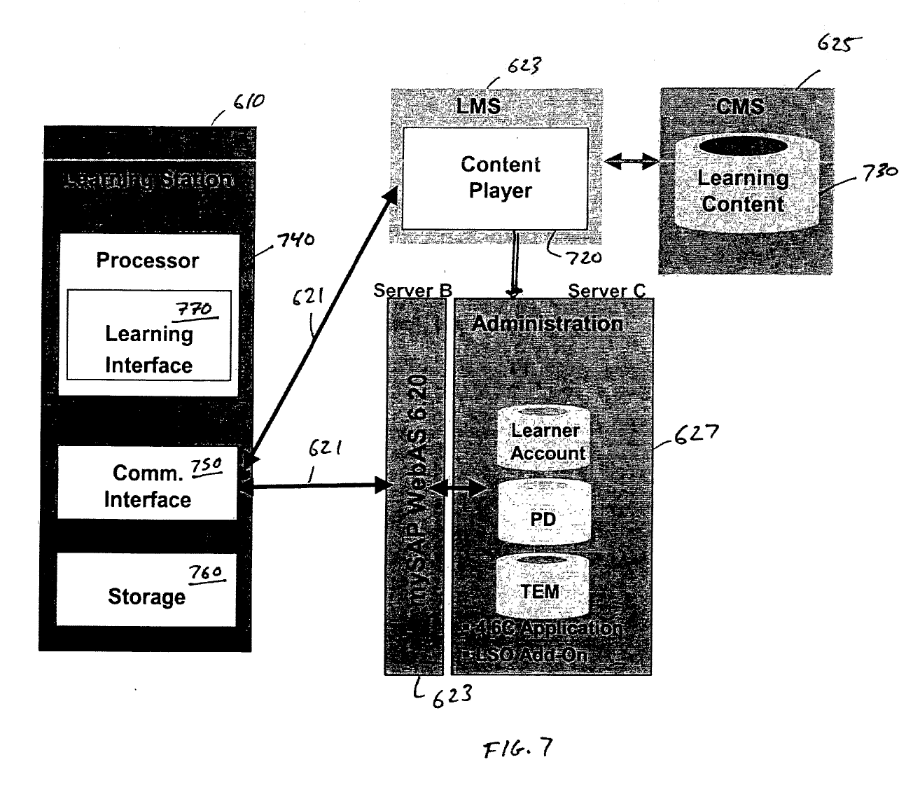

As shown in FIGS. 6 and 7, the administration management system 627 may be implemented using a server, such as, for example, the SAP R/3 4.6C+LSO Add-On. The administration management system 627 may include a database of learner accounts and course information. For example, the learner account may include demographic data about the learner (e.g., a name, an age, a sex, an address, a company, a school, an account number, and a bill) and his/her progress through the course material (e.g., places visited, tests completed, skills gained, knowledge acquired, and competency using the material). The administration management system 627 also may provide additional information about courses, such as course title, description, courses offered, the author/instructor of a course, and the most popular courses.

The content management system 625 may include a learning content server 730. The learning content server 730 may be implemented using a WebDAV server. The learning content server may include a content repository. The content repository may store course files and media files that are used to present a course to a learner at the learning station 610. The course files may include the structural elements that make up a course and may be stored as XML files. The media files may be used to store the content that is included in the course and assembled for presentation to the learner at the learning station 610.

The learning management system 623 may include a content player 720. The content player 720 may be implemented using a server, such as an SAP J2EE Engine. The content player 720 is used to obtain course material from the content repository. The content player 720 also applies the learning strategies to the obtained course material to generate a navigation tree or path for the learner. The navigation tree or path is used to suggest a route through the course material for the learner and to generate a presentation of course material to the learner based on the learning strategy selected by the learner. Course navigation is described in further detail below.

The learning management system 623 also may include an interface for exchanging information with the administration management system 627. For example, the content player 720 may update the learner account information as the learner progresses through the course material to indicate, for example, competencies gained, tests passed, courses completed.

Learning Station

The learner may access information about a course, content associated with a course, information about the learning system 620, and information about the learner (e.g., the learner account) using the learning station 610. As shown in FIG. 7, the learning station 610 may include a processor 740, a storage device 750, and a communications interface 760. The learning station also may include any number of peripherals or integrated devices (not shown) (e.g., displays, memory/storage devices, input devices, ports/interfaces, printers, communication cards, and speakers) that facilitate access to, presentation of, and interaction with the course, its content, and associated course information.

The processor may be used to implement a learning interface 770. For example, the processor may execute any number of software applications including a learning interface that is configured to access, interpret, and present a course and associated information to a learner, and to allow a learner to interact with the content and the learning system. The learning station also may provide access to learner account information.

The software may include a browser, such as, for example, Netscape communicator, Microsoft's Internet explorer, or any other software application that may be used to interpret and process a markup language, such as HTML, SGML, DHTML, XML, or XHTML.

The browser also may include software plug-in applications that allow the browser to interpret, process, and present different types of information. The browser may include any number of application tools, such as, for example, Java, Active X, JavaScript, and Flash.

The communications interface may facilitate the exchange of data and information between the learning station and the learning system. For example, the communications interface may be a communications card, a modem, a port, a transceiver or a device that provides a connection to the communications link 621. Data may be received from the learning system and processed by the processor and/or stored in the storage. Similarly, data processed by the processor and/or stored in the storage may be transmitted to the learning system.

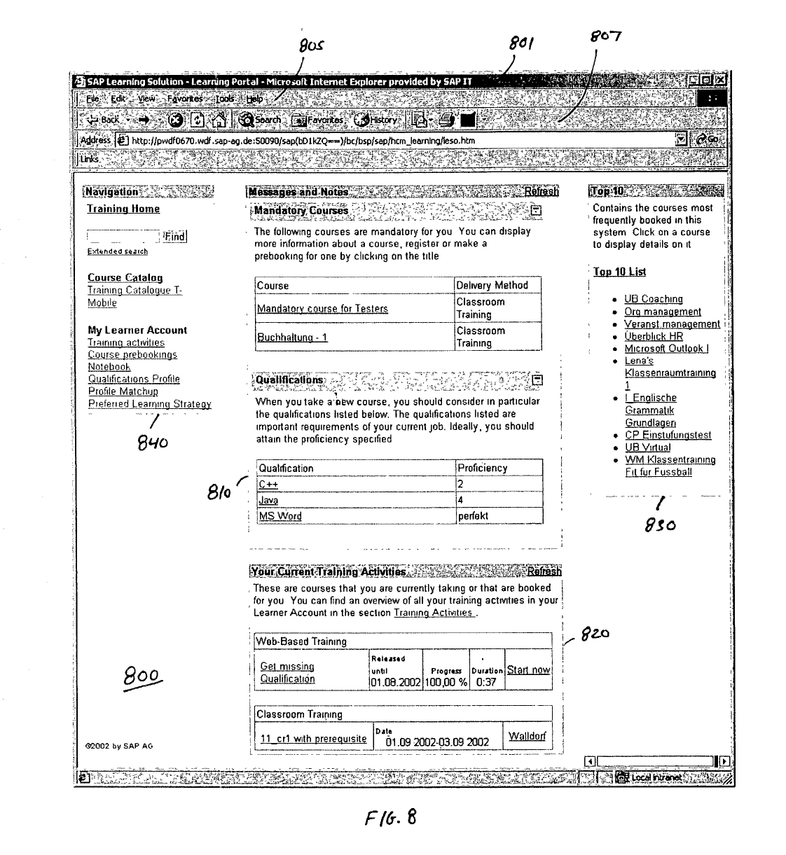

As described above, the learner may contact the learning system using the learning station to access a course. The learning interface and associated browser may be used to implement a graphical user interface that accepts information input from the learner and presents information received from the learning system. FIGS. 8-21 illustrate various functions and display windows that may be used to implement the graphical user interface. Each of the figures is discussed in detail below.

Learning Interface

The learning interface may be used to search a course catalog, book and cancel course participation, and support individual course planning (e.g., by determining qualification deficits and displaying a learner's completed, started, and planned training activities). The learner also may access and work through web based courses using the learning interface. The learning interface may be used to start a course, reenter a course, exit a course, and take tests. The learning interface also provides messages, notes, and special course offerings to the learner.

A personalized learner account is stored by the learning administration system. The learning management system uses the account information to prepare displays for the learner and to facilitate the learner's interaction with the learning system. The learner account includes information about training activities (e.g., completed, in process, and planned course), course prebookings, a notebook, qualifications, qualification matchups, and a preferred learning strategy. The learning interface may be used to view and to interact with the learner account information.

FIG. 8 shows an initial learner interface screen 800 that is presented by the learner interface. The screen 800 may include a title bar 801, a menu bar 805, and a tool bar 807. In addition, the screen 800 may include a number of windows including a message and notes window 810, a current activities window 820, a top 10 window 830, and a navigation window 840.

The message and notes window may be used to provide access to information about courses. For example, an employer may use the messages and notes window to distribute company wide information about courses to all employees. The messages and notes window also may be used by the employer to determine whether an employee has received, read, and/or confirmed receipt of the information. For example, the learning administration system may determine when a message is delivered to an employee, when an employee accesses a note or message using the window, and/or when an employee confirms or acknowledges receipt of a message.

As shown in FIG. 8, the message and notes window may include a mandatory courses section containing courses that are prescribed for the learner, a qualifications section displaying essential requirements for a learner (e.g., related to a learner's job description), and an area displaying the scheduled dates of courses for which the employee is prebooked (not shown). The learning administration system may generate a list of courses that impart any necessary qualifications based on the learner's qualifications stored in the administration system. The learning management system may access this information when generating the messages and notes window.

A current training activities window may be used to provide the learner with detailed information on personal training activities that are planned and/or are currently in process. Current training activities may include courses that the learner has booked for a fixed date in the future (e.g., classroom training) and courses that the learner has booked that have no scheduled course date (e.g., web based courses). The learner also may start an active web based course by selecting a start now hyperlink. Depending on the type of course, the current training activities window may display course details (e.g., information from the course catalog), details about a scheduled course (e.g., participant list or course location).

The learning administration system may generate a top 10 list of the courses most frequently booked using the learning system. The top 10 list may be displayed in the top 10 window. The top 10 window also may be used to create a specialized course offering list (e.g., a course list specific to a particular company, university, or organization).

The navigation window may be used by the learner to navigate through the various information that is provided by the learning system. The navigation window may include a hyperlink to a home page (e.g., the initial screen 800), a find field, a course catalog hyperlink and various learner account hyperlinks.

The find field may be used to search for courses using a keyword contained in the title or course description. A learner may enter keyword information in the find field using an interface (e.g., a keyboard connected to the learning station). Selecting the find button creates a hit list (not shown) that displays a list of course information that corresponds to the keyword. The learner may display detailed information from the hit list by selecting a hyperlink directly from the hit list. The search function may be used to find a course without having to browse through the course catalog.

For example, if a learner wants to improve his or her knowledge of English, the learner may enter the keyword English and start a search. The resulting hit list displays all courses and delivery methods found that have the keyword English in the course title or description. The learner may select a course from the hit list and display further details about the course, such as course dates or prerequisite qualifications for the course.

The navigation window also provides an extended search hyperlink that may be used to restrict search criteria (e.g., if the hit list includes too many items). The extended search hyperlink also may be accessed from the hit list. The learning interface may be automatically configured to display the extended search hyperlink if a hit list resulting from a search contains more than a predetermined number of entries (e.g., 20 entries).

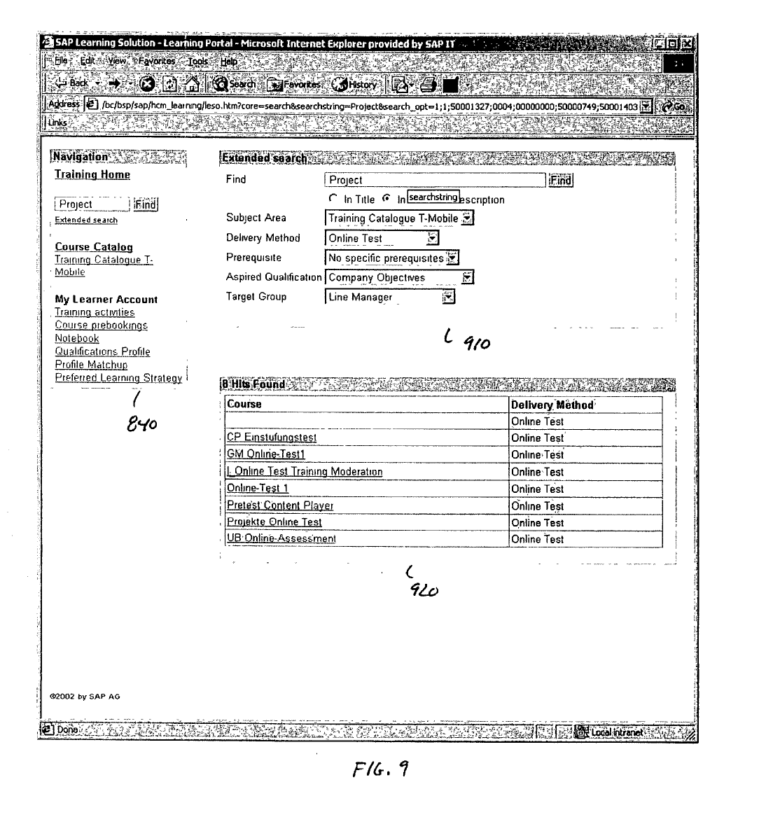

As shown in FIG. 9, an extended search window 910 may be used to restrict search criteria and specify, for example, whether the keyword search should be executed for the course title or the course description. The search also may be refined using a number of search entries that include a subject area, a delivery method, a course prerequisite, an aspired qualification, and a target group. A field may be provided for each of these entries including a drop-down menu (which may use to populate the fields). All of the extended search entries are optional allowing a learner to select one or more as desired.

For example, if the keyword search for English courses returns a large number of courses, the learner may use the extended search function to limit the search. For example, if the learner is only interested in in-house courses, the learner may select in-house training from the delivery method field (e.g., which lists of all of the delivery methods available in the system). Selecting find produces a hit list that displays all courses with English in their title or description that are classified as in-house courses. A hit list window 920 may be provided to show the results of the search (which may be further refined using the extended search window). A course may be directly selected from the hit list window.

The navigation window is provided with a number of hyperlinks to other windows. The hyperlinks may used to navigate through the information presented by the learning interface. For example, the navigation window may include a course catalog, a specific training catalog, and specific learner account information (e.g., including training activities, course prebookings, a notebook, a qualifications profile, a profile matchup, and a preferred learning strategy).

The course catalog (not shown) allows a learner to navigate through any courses offered by the learning system. Courses may be provided using several different delivery methods, such as online learning or classroom training. As described above, the learner may use the search features to find a specific course in the catalog.

Courses also may be accessed from the list of subject areas in the navigation window and from the overall view provided by the course catalog. Subject areas constitute a thematic structuring of the offered courses. The use of subject areas enables the courses to be structured thematically rather than hierarchically and thus present a picture of the overall structure of the courses. The learner may access a detailed screen of a subject area and course using the interface (both of which are described in detail below).

The courses may be displayed in the catalog overview according to their subject areas. The learner may access a subject area or a course by selecting a hyperlink from the course overview. Selecting a hyperlink accesses a corresponding detailed screen with all of the relevant information and descriptions. An example of a course catalog structure is shown below.

Course Catalog

| Subject | | | |
|---|---|---|---|
| Areas | | Computer | Personnel |
| (Course groups) | Languages | Science | Management |
| Assigned Subject | English | Programming | Recruitment |
| Areas | French | Languages | Personnel |
| (Course groups) | | Databases | Development |
| | | Networks | Shift Planning |
| Courses | Business | Java Script | Holding Employee |
| (Course types) | English I | C++ | Reviews |
| | Technical | | |
| | English | | |

As shown in FIG. 10, the subject area window 1010 may be used to display all data relevant in a subject area. The subject area window may include the subject area, a general description of the subject area, courses assigned to the subject area, and a hyperlink to add the subject area to a learner's notebook. The subject area window also may include a navigation route from the course catalog to the current page.

Courses also may be offered as part of a curriculum. A curriculum is a collection of courses that may be booked in one step. Alternative courses may be offered for any course within the curriculum. If alternative courses are offered, the learner must decide which of the alternatives within the curriculum are desired before booking a curriculum. The curriculum course information displayed depends on the delivery method of the courses contained in the curriculum (e.g., whether the courses are time-dependent or time-independent). The learning system provides a display of the courses that make up the curriculum in a planned sequence; however, the actual sequence of the courses in the curriculum can deviate from the planned sequence.

The learner may book a curriculum directly from the course catalog or the find function in the navigation window. Once the curriculum is selected, the prerequisites or required knowledge (e.g., qualifications) for booking the curriculum are displayed. If the learner does not have the prerequisites, the system displays the course or courses that impart the required qualifications. The learner may select the curriculum and book it directly if the prerequisites for the curriculum are fulfilled, and there are not multiple alternative courses possible for any course of the curriculum.

If some elements of the curriculum specify alternative courses, the learner must select one of the alternatives in each case before booking the curriculum. For example, a curriculum for Java programming may include, a five-day introductory course, a three-day advanced course, and an online certification. The capacity of the introductory course may be 30 participants, but the capacity of the advanced course may be only 10 participants. In order to give all 30 participants the opportunity of attending the advanced course, the curriculum offers three alternative advanced courses. Before booking the curriculum, the learner must decide which of the three alternatives to take.

Detailed course information may be displayed based on the course delivery method (e.g., time-independent courses, such as Web-based courses, or time-dependent courses, such as classroom training).

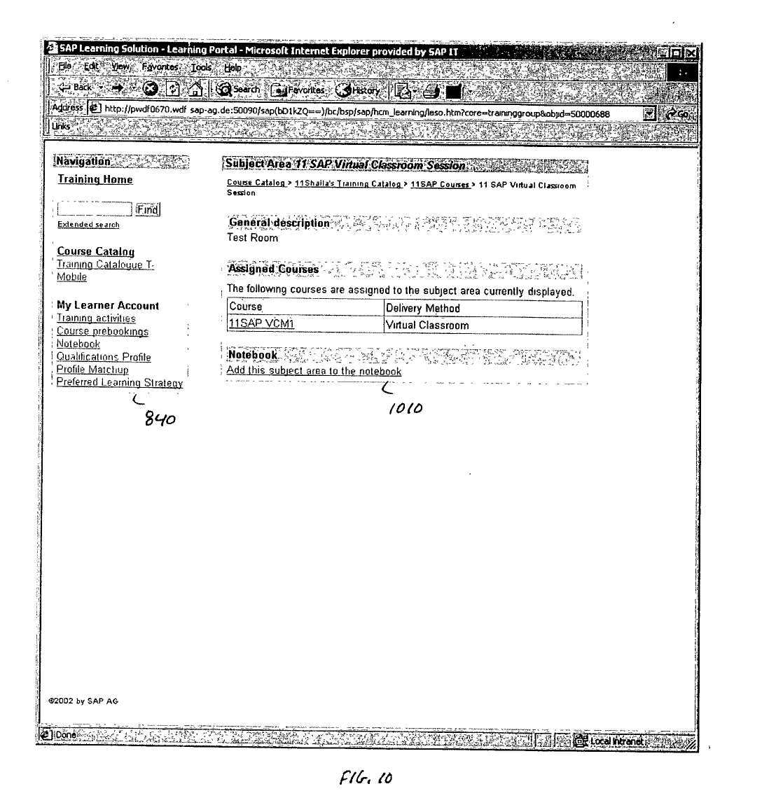

As shown in FIG. 11, the detailed display for a web based course window 1110 includes a navigation route from the current page to the course catalog. The navigation route provides the learner with an orientation and pinpoints where the learner is in the course catalog. Status messages about current operations (e.g., booking, prebooking, notebook) also may be displayed. For example, if the learner has made a booking, a prebooking, or added a course to the learner's personal notebook, an appropriate message may be displayed (e.g., “The results of the prequisites check indicate that you can book this course”). The message may describe the status of the operation performed. For example, the message may include information about whether a booking or prebooking may be made, or for what reasons it cannot be made.

The web based course window may display course content including a title and a course description. Notes may provide additional information about the selected course. Time duration information may be included (e.g., a minimum, an optimum, and a maximum completion time). In addition, course availability information (e.g., a period of time from the date of the course booking during which the course is available to the learner) may be displayed.

The web based course window may include a target group that designates a group of learners for which a course is designed. A list of prerequisites also may be displayed that includes the required qualifications that a participant of the course should obtain before beginning the course. A hyperlink may be provided to display the courses providing the required qualification. The web based course window also may include a listing of attainable qualifications that may be attained through successful completion of a course. The system also may display the proficiency of the qualification imparted.

Follow-up courses and the corresponding course delivery methods may be suggested. Fees charged for course participation also may be displayed. If a course is offered in multiple languages, the various languages may be displayed and selected by the learner.

A course owner (e.g., the person responsible for authoring the course) also may be displayed in the web based course window. If the learner is given the required authorization, the course owner's e-mail address may be accessed by selecting the course owner name (e.g., causing an e-mail window may automatically appear populated with the address). The name of the training provider may be displayed, and, with the required authorization, the learner may access the training provider's home page by clicking the name. Hyperlinks may be provided to access further information on the Web.

The web based course window may display the progress of the learner including, for example, the dates of the first and last course access, the number of structural elements within the course completed, the percentage of the course completed, the number of learning objectives already achieved, and the completion time to date in minutes.

The course displayed in the web-based course window may be added to the learner's personal notebook. The learner may book the course directly using the hyperlink provided. In addition, the learner may start working on the course immediately by selecting a start hyperlink. The learner also may stop working on the course and resume working on a course where the course was interrupted using the web based course window. The learner may set the course as completed when the course has been finished. Any the learning objectives that have been achieved are entered as qualifications in the learner account.

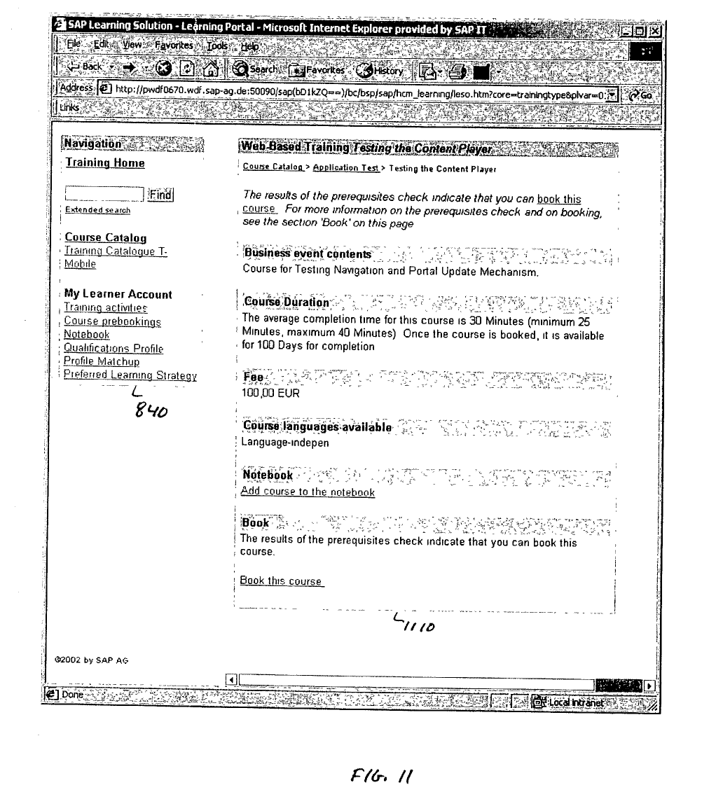

As shown in FIG. 12, the general course window 1210 for a time-dependent course may include a title and a navigation route to show the location of the window in the course catalog. The general course window may include a course duration and any related follow-up courses. A fee for booking the course may be included.

The course dates for a designated time period that the course is offered (e.g., the next 90 days) may be displayed. If none of the dates are suitable, the learner may enter alternate dates to check course availability. For each date that a course is offered the display may include the start date, the end date, the course location, the language in which the course will be held, and the number of free places left in the course. The learner may be offered the choice to book or prebook a course directly from the general course window using a registration hyperlink or a prebook hyperlink. A training provider of the course also may be displayed. A hyperlink to add the course to the learner's notebook also may be provided.

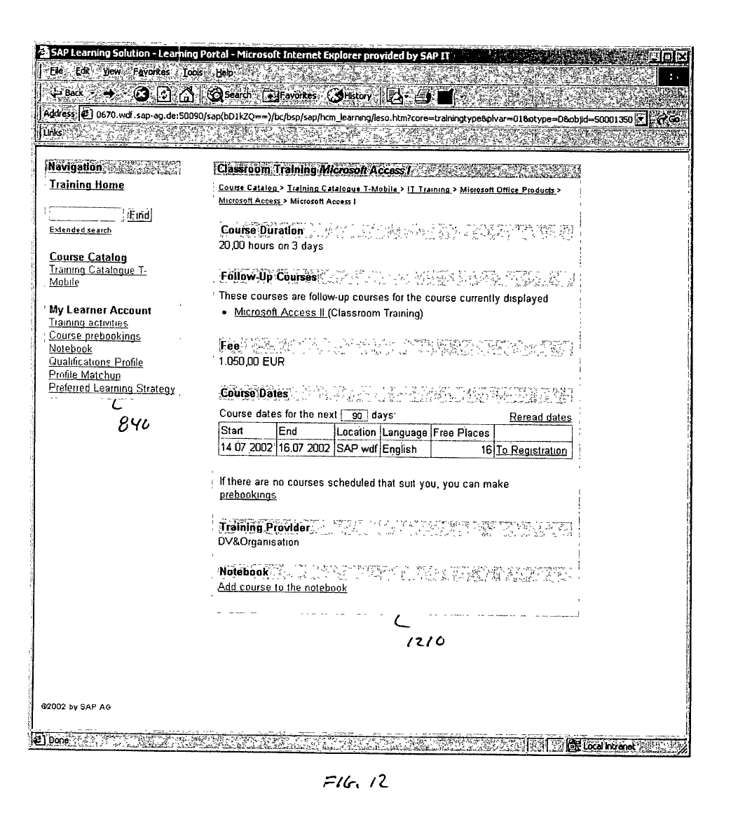

A detailed course window 1310 for a particular instance of a course is shown in FIG. 13. The detailed course window includes a title, a navigation route, and a message area. A schedule for the course may be provided. The course duration, trainer (e.g., instructor), fee, language, location, and training provider may be displayed. A hyperlink to add the course to the learner's notebook, and a hyperlink to book the course may be provided.

The description in the detailed course window for time-dependent courses includes a schedule of times the course is offered. The course duration also is displayed including, for example, the total number of course hours and days. A participant list may be displayed if the learner has the required authorization. In addition, e-mail addresses may be accessed from the participant list with the required authorization.

A waiting list may be provided if the course is full. The learner may make or cancel a waiting list booking directly from a hyperlink provided in the waiting list. The name of the training instructor may be displayed along with the location that the course is offered (e.g., the room number and directions).

The learner account provides the learner with a clear overview of learning activities and supports personal decision making processes of the learner. The learner account includes courses that are planned, in process, and completed by the learner. Learners may view their own qualifications, appraisals, and test results using the learner account. In addition, learners may appraise completed courses online, which may be used to improve course offerings. Based on the results of the learner's qualification matchup with a requirements profile, the learning system can automatically generate a suitable offering of courses. The personalized account for the learner that includes training activities, course prebookings, a notebook, a qualifications profile, a profile matchup, and a preferred learning strategy. Each of these areas may be accessed directly from the navigation window.

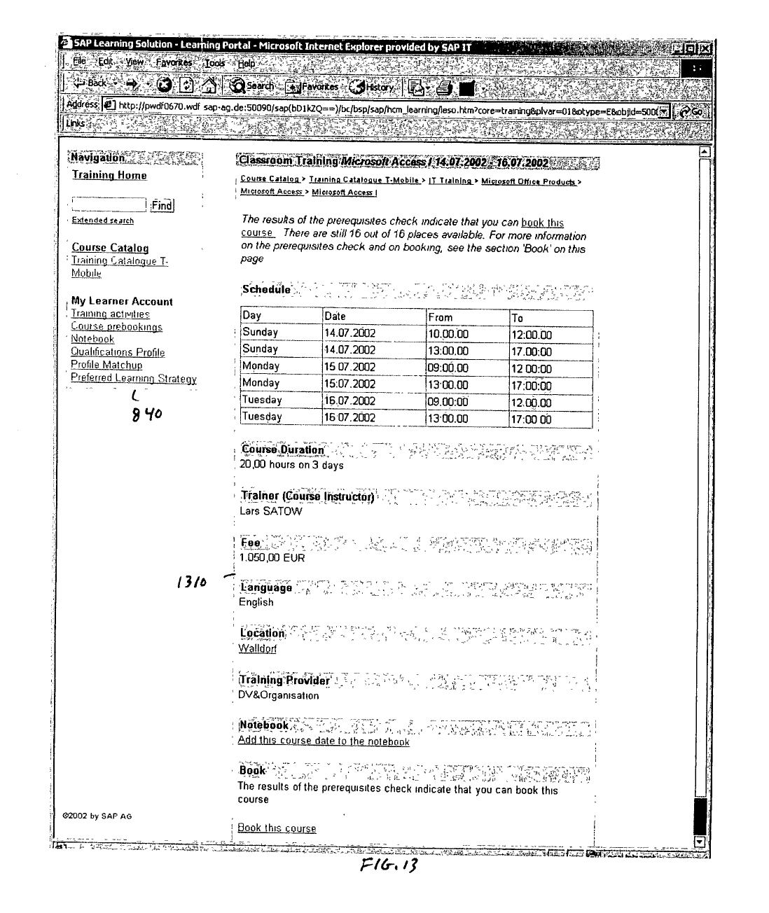

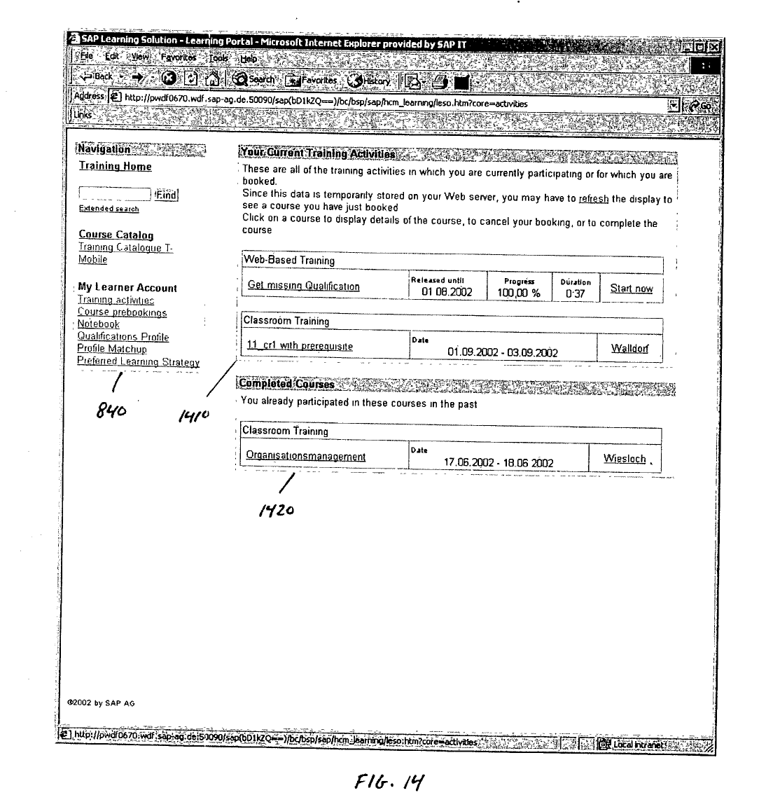

As shown in FIG. 14, the training activities window 1410 provides the learner with detailed information on training activities that are planned, in process, and completed. The training activities window may include a title and messages. The training activities may be classified as current training activities (e.g., courses displayed on the initial screen of the learning interface) and completed training activities. From the list of training activities, the learner may display courses and tests. In addition, current training activities may be divided into web-based and classroom training activities. A separate window 1420 may be provided for completed courses.

As shown in FIG. 15, a prebook window 1510 may be used to prebook a course that the learner is interested in taking if the current course offerings do not match those desired by the learner, for example, if the scheduled dates, languages, and/or locations of the offered courses are not suitable. The prebooking window allows the learner to propose alternative dates, course languages, and/or locations to the learning system. The learning management system monitors prebooked courses and may arrange to schedule or design a course if, for example, there is enough interest. The learner may be informed in the messages and notes window when a course is scheduled that meets the learner's requirements.

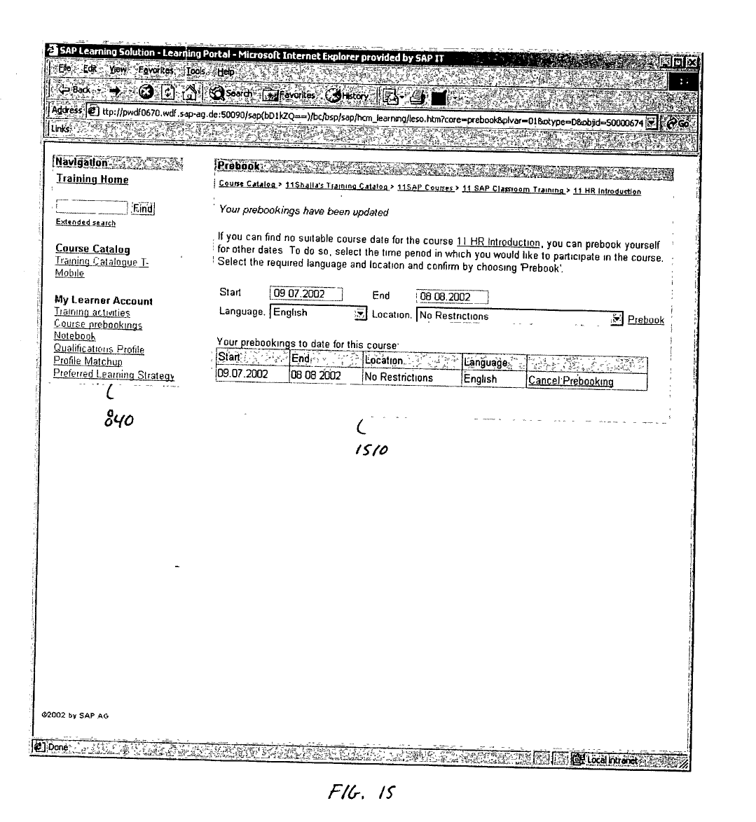

As shown in FIG. 16, the my course prebookings 1610 window lists current prebookings, which may be cancelled as required. The prebooked course list may include the course name, the period, the location, the language, and a hyperlink to cancel the prebooking.

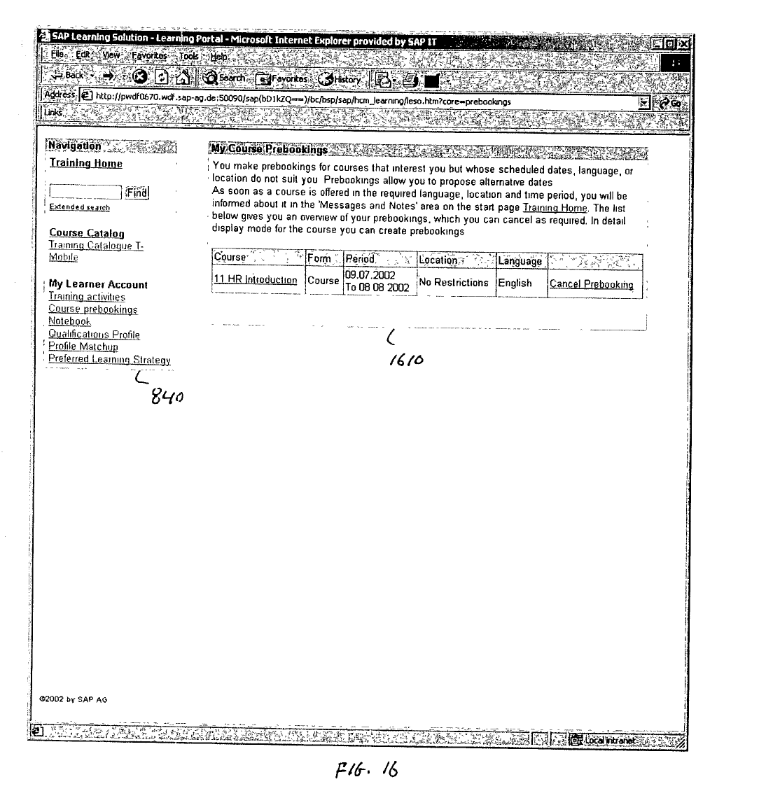

As shown in FIG. 17, the notebook window 1710 facilitates learner interaction with the learning system. Using the notebook, the learner may store and quickly access individual, learner-specific information. The notebook may include information for learner qualifications, subject areas, courses, and course dates. The notebook window allows the learner to view the individual areas within the notebook and add information of interest to the notebook and remove it as required (e.g., using the remove object hyperlink).

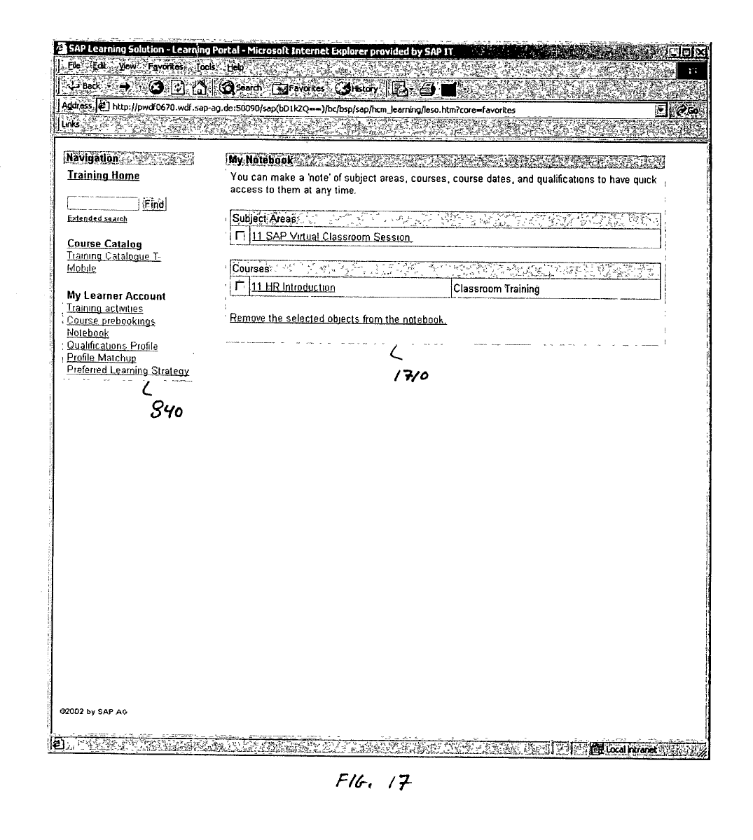

As shown in FIG. 18, the qualifications window 1810 describes qualifications that are assigned to a learner through the administration system. The qualifications are displayed in a list that is structured by qualification groups. The list also displays the learner's proficiency for each qualification. From the qualifications window the learner may access detailed information about any qualification. The display includes information about the meaning of the qualification (e.g., a description), the scale and value range on which the proficiency of the qualification is based, any qualifications defined as alternative qualifications, the learner's current proficiency, and course types that impart the qualification. A hyperlink to display an explanation of the qualifications may be provided. In addition, the learner may perform a profile matchup that compares the qualification with requirements profiles.

Selection of the profile matchup hyperlink (either from the qualifications window or the navigation window) displays the profile matchup window 1910, as shown in FIG. 19. The profile matchup window allows the learner to match their qualifications profile with various requirements profiles. The matchup window informs learners of any qualifications that need updating or qualifications need to be acquired. Using the profile matchup window, the learner is able to match qualifications with requirements profiles including requirements profiles of a learner's current position or job, a job for which a learner is designated, and/or a development plan to which a learner is assigned.

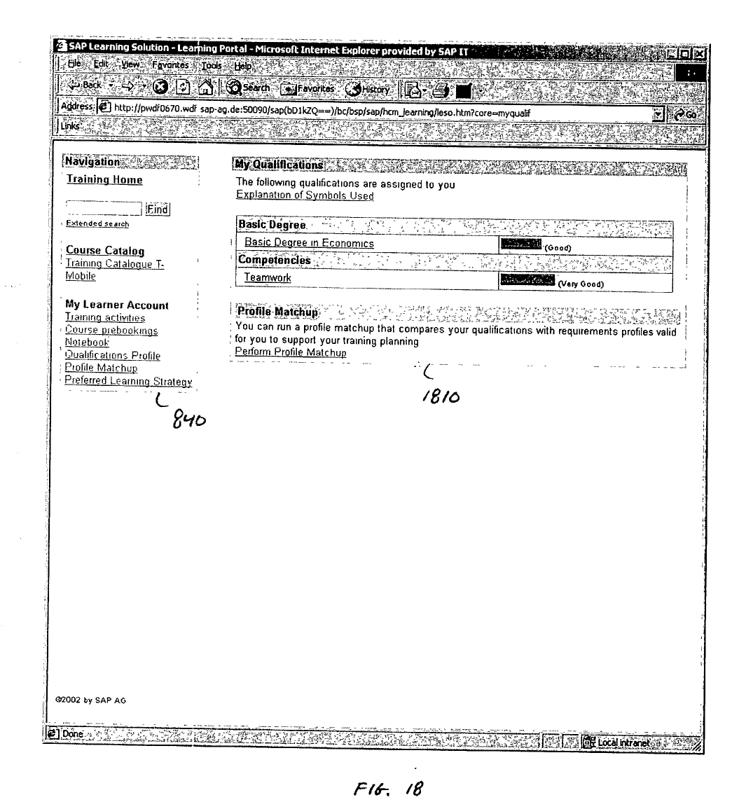

The learning administration system may be used to match a learner's qualifications profile with the requirements profiles to determine the learner's qualification deficit for the learner's current job, a job or position for which the learner is designated, or the learner's development plan. The learning administration system highlights any qualifications in the requirements profile that the learner does not have at all or does not have not with the required proficiency. The learner may access detailed information about any qualification from the qualifications display. As shown in FIG. 20, the learning strategy window 2010 allows the learner to choose from a number of learning strategies available. The learning strategy window may include learning macro strategies, micro strategies, and combinations of both macro and micro strategies. The learning strategies are described in detail above. The learner may select a learning strategy using a drop-down menu 2020.

Once an on-line or Web-based training course has been booked, a learner may proceed to take web based course using the learning station. When the learner is ready, the learner selects a web based course that has been booked and starts the course. The learning management system obtains the preferred learning strategy that is stored in the learner's account. In addition, the content player obtains the course content and structure from the content repository of the content management system. The content player guides the learner through the course using learner's selected learning strategy. The content player also dynamically adapts the number and sequence of topics contained in the course to learner's individual learning style using the selected learning strategy. The sequence in which content of course is presented to the learner also may be assembled on the basis of the learner's progress.

When a learner starts the course, the learning objectives and qualifications that have been achieved may be compared with the qualifications imparted by the course. As a result, the content player may selectively withhold redundant content for qualifications already achieved by the learner.

If the learner interrupts and then resumes a course, the content player opens the course at the point of interruption. Once a course has been successfully completed, the learning objectives that have been achieved are credited as qualifications to the learner's account in the learning management system.

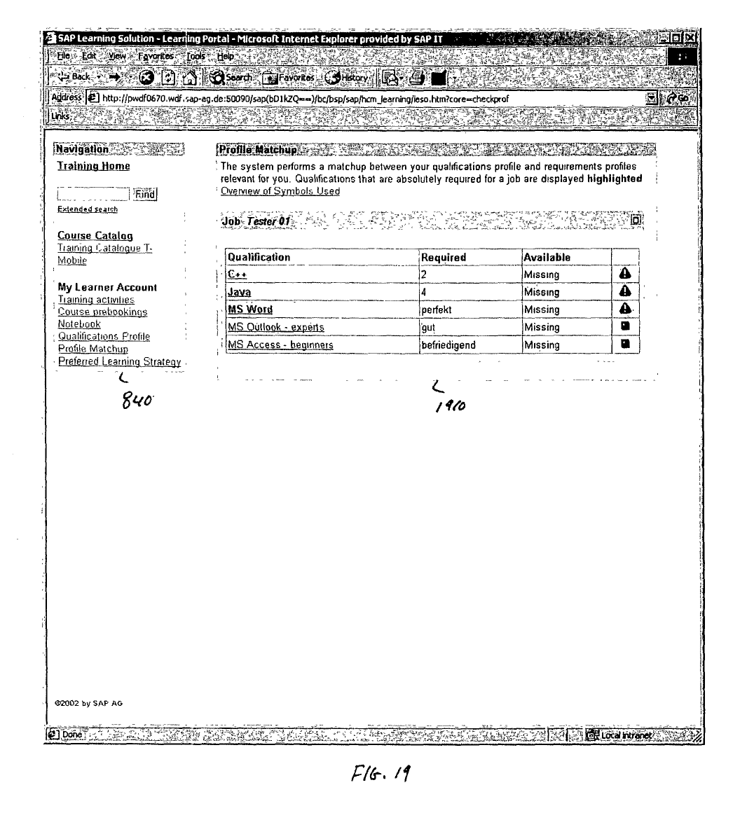

FIG. 21 shows a course screen 2100 that may be presented by the learner interface. The screen may include a content area 2110, a table of contents window 2120, a navigation path window 2130, and a navigation bar 2140.

As shown in FIG. 21, the subject of the course is displayed in the upper part of the learner interface screen. The course content may be displayed in the center content area. The navigation bar may be located across a lower portion of screen. There are a number of functions available to display the course in the learning interface. A learner does not have to proceed through the course in a linear fashion. Instead, the learner may jump between topics and content. The navigation bar may be used to activate all of the navigation functions to proceed through the course. Any of the navigation functions may be selected through use of a learner input device (e.g., a keyboard and cursor or clicking on a function using a pointer and a mouse).

The navigation bar may include the functions back, note, continue, table of contents, and path. Back may be used to return to the previous topic or content presented in the course screen. Note may be used to take into account navigation steps from other sessions. Continue may be used to move on to the next topic in the course. The table of contents may be used to display an overview of the content of a course. The path function may be used to display a navigation path through the course.

Selecting the table of contents function from the navigation bar causes the table of contents window to appear on the course screen. The table of contents window may be resized and dragged to any location on the screen. In addition, the window may be closed, minimized, and maximized. If all the contents of the window cannot be displayed in the window at the same time, a scroll bar is provided to access the contents. The table of contents window includes the course topics presented in the sequence in which the author created them. This sequence is independent of the learning strategy selected. Entries in the table of contents that a learner may access may be highlighted in color and/or identified by a symbol. Access to these entries depends on the completion status of the course elements and the learning strategy selected.

Selecting the path function from the navigation bar causes a navigation path window to appear on the screen. The navigation path window may be resized and dragged to any location on the screen. In addition, the navigation path window may be closed, minimized, and maximized. If all the contents of the navigation path window cannot be displayed at the same time, a scroll bar is provide to access the contents. The navigation path window may be used to see the learner's exact location within a course. The navigation window includes a navigation path of the structural elements of the course and depends on the learning strategy selected. The learner may navigate to structural elements displayed on the navigation path (and any associated content) by selecting the structural element.

The topic or name of the content currently presented in the content area is displayed in the upper part of the course screen. One or more indicators may be appended to the topic or name, for example, currently in process, completed or displayed, completion is not yet recommended, the element is a test element.

To exit the course, the learner may choose the Log off function from the navigation bar. Once the logged off, the achieved learning objectives are entered in the learner account. The learning administration system stores the point at which the course was interrupted to ensure that the learner can resume the course at the same point.

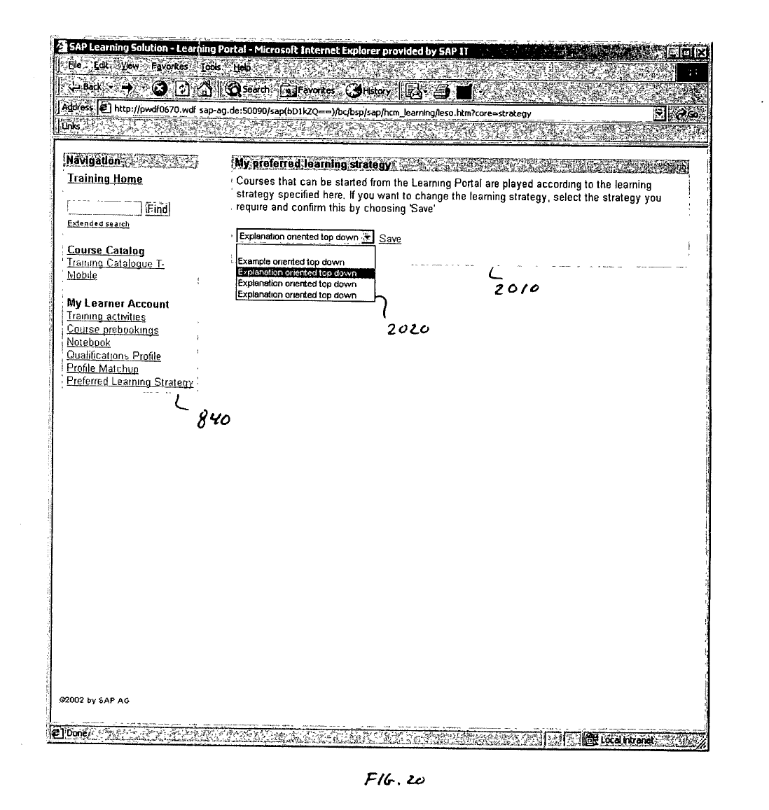

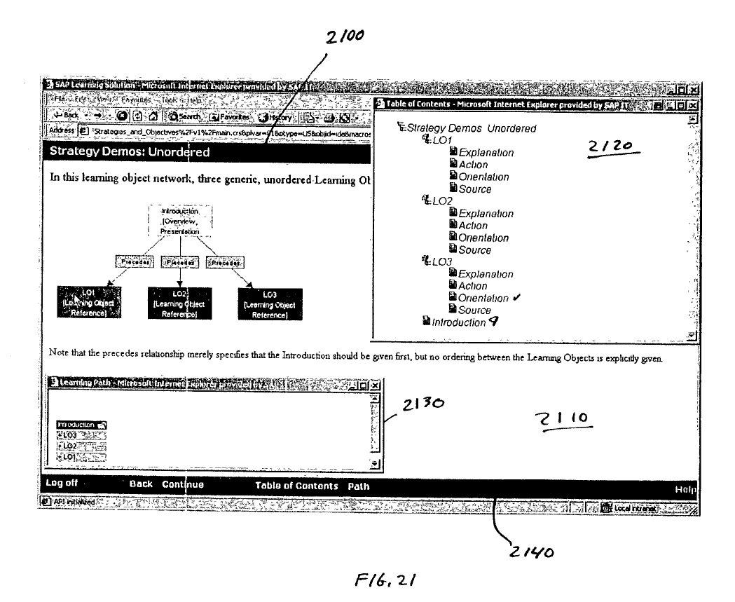

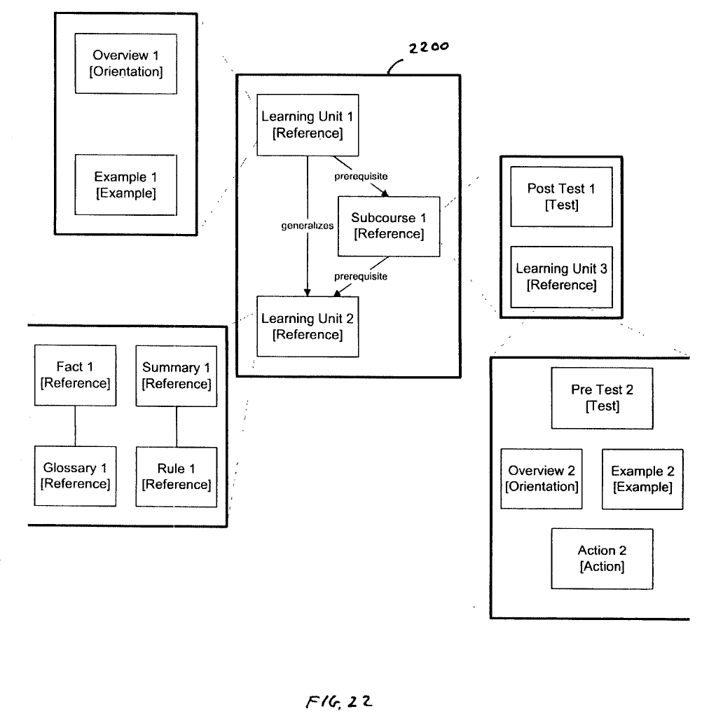

FIG. 22 is a graphical representation of a course 2300 that may be used to illustrate the construction of navigation paths in FIGS. 23-27. As shown in FIG. 22, a course 2300 includes a learning unit 1, sub course 1, and learning unit 2. Learning unit 1 includes two knowledge items: overview 1 and example 1. Sub course 1 includes post test 1 and a learning unit 3. Learning unit 3 includes knowledge items pretest 2, overview 2, example 2, and Action 2. Learning unit 2 includes the knowledge objects fact 1, glossary 1, summary 1, and rule 1.

Each of the structural elements includes a type of knowledge attribute (shown in brackets). For example, Fact 1, Summary 1, glossary 1, rule 1, learning unit 1, learning unit 2, learning unit 3, and sub course 1 all include knowledge of reference. Overview 1 and overview 2 include knowledge of orientation. Example 1 and example 2 include knowledge of example. Action 2 includes knowledge of action.

A number of relations are provided between the structural elements. The directional relation “is a prerequisite of” is provided from learning unit 1 to sub course 1 and from sub course 1 to learning unit 2. The directional relation “generalizes” is provided from learning unit 1 to learning unit 2. The Non-directional relations “belongs-to” are provided between fact 1 and glossary 1 and summary 1 and rule 1

In order to guide a learner through the content of a course associated with the structural elements, a navigation path is generated by the content player based on the learning strategy selected by the learner. The navigation path displayed in the navigation path window may be divided into two portions. A lower portion shows the structural elements that may be reached from the learner's current position within the course. A bar above this portion shows all of the knowledge items within a structural element that is currently being navigated by the learner. A dark color or highlight may be used to indicate the knowledge item and structural element associated with the content that is being presented by the content player.

A number of symbols may be associated with the structural elements to convey information to the learner. Symbols may be useful to individuals who have difficulty distinguishing colors on the screen. For example, an open folder may be used to indicate the structural element is currently being accessed or displayed. A check mark may be use to indicate a structural element that has been completed and/or presented to the learner. A lock may be used to indicate that navigation to a structural element is not recommended at that point in the course. Four buttons in a square may be used to indicate an uncompleted test element.

As shown in FIG. 23, a navigation path is generated for the course shown in FIG. 22 using a top down macro learning strategy. The three structural elements learning unit 1, sub course 1, and learning unit 2 are shown in the lower portion of the navigation path window. A dark color and folder symbol indicate learning unit 1 and overview 1 are being accessed or viewed. The bar above the lower portion shows the knowledge items overview 1 and example 1 within in the learning unit 1. As shown in FIG. 23, learning unit 1 has not been completed. In addition, learning unit 1 is a perquisite for sub course 1 and learning unit 2. As a result, lock symbols are displayed on sub course 1 and learning unit 2 to indicate navigation to these elements is not recommended.

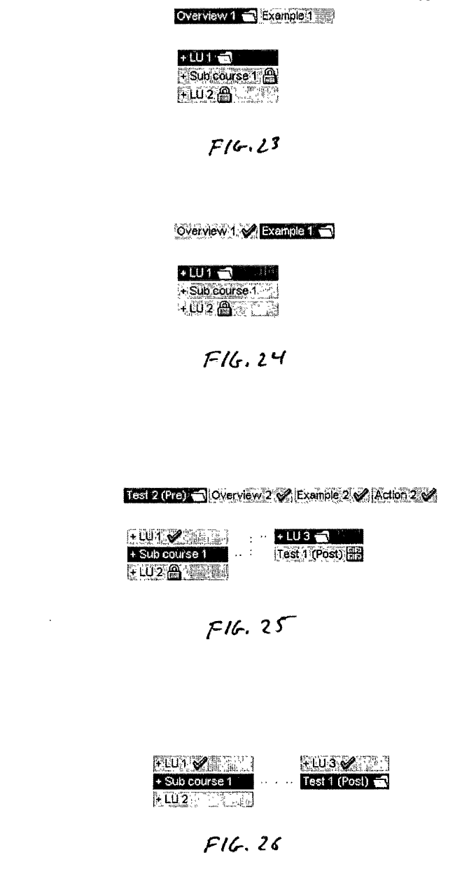

As shown in FIG. 24, the knowledge item overview 1 and example 1 have now been completed. As a result, sub course 1 is offered (i.e., the lock symbol is removed), however, the lock symbol remains on learning unit 2 (i.e., because the completing sub course 1 is a prerequisite for beginning learning unit 2).

FIG. 25 shows the learner has navigated to sub course 1. The structural elements learning unit 3 and test 1 within sub course 1 are displayed next to the course structural elements. A dotted line may be shown to indicate which structural element includes the second set of structural elements. The bar at the top shows the knowledge items within the learning unit 3 (i.e., test 2, overview 2, example 2, and action 2). The check marks indicate that the knowledge items have been completed. The four buttons next to test 1 indicate the test has not been completed. As a result, learning unit 2 is still not offered. As shown in FIG. 25, the learner has completed Learning unit 3 and test 1. As a result, as shown in FIG. 26 the prerequisites for learning unit 2 have been completed and the lock is removed from learning unit 2. No bar is shown at the top of the display because the test 1 does not contain any knowledge items.

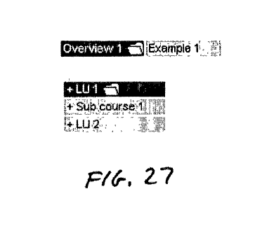

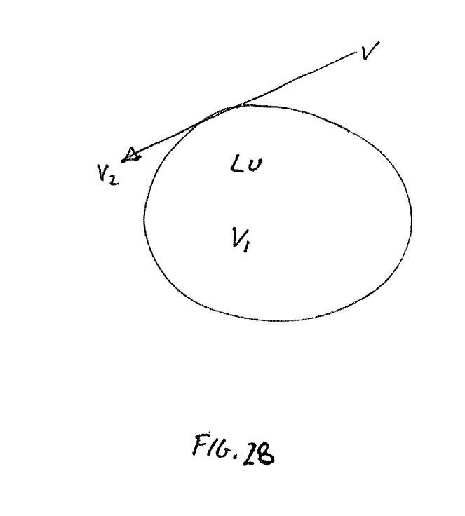

As shown in FIG. 27, using the navigation strategy index, all relations are ignored. As a result, all elements are offered in the navigation path.

Course Navigation

The structure of a course is made up of a number of graphs of the structural elements included in the course. A navigation tree may be determined from the graphs by applying a selected learning strategy to the graphs. The navigation tree may be used to navigate a path through the course for the learner. Only parts of the navigation tree are displayed to the learner at the learning portal based on the position of the learner within the course.

As described above, learning strategies are applied to the static course structure including the structural elements (nodes), metadata (attributes), and relations (edges). This data is created when the course structure is determined (e.g., by a course author). Once the course structure is created, the course player processes the course structure using a strategy to present the material to the learner at the learning portal.

To process courses, the course player grants strategies access to the course data and the corresponding attributes. The strategy is used to prepare a record of predicates, functions, operations, and orders that are used to calculate navigation suggestions, which is explained in further detail below.

The content player 720 accesses files (e.g., XML files storing course graphs and associated media content) in the content repository and applies the learning strategies to the files to generate a path through the course. By applying the learning strategies the content player 720 produces a set of course-related graphs (which is simply an ordered list of nodes) that are used to generate a navigation tree of nodes. The set of nodes may be sorted to generate an order list of nodes that may be used to present a path through the material for a learner. The embedded LMS 760 also may generate paths in the same manner. In general graphs and strategies may “interact” in the following ways:

1. A strategy implements a set of Boolean predicates that can be applied to graph nodes. For example: isCompleted (node).

2. A strategy may be informed by an event that some sort of action has been performed on a graph node. For example: navigated (node).

3. A strategy may provide functions that are used to compute new node sets for a given node. For example: NavigationNodes (node).

4. A strategy provides an ordering function that turns node sets computed number 3 into ordered lists.

5. A strategy may decide to alter certain strategy-related node attributes. For example: node.setVisited(true).

Note that the last point is used because a strategy does not keep any internal state. Instead, any strategy-related information is stored in graph nodes' attributes allowing strategies to be changed “on the fly” during graph traversal.

As described there are sets of nodes that may be used to generate a path through a course. One set of nodes is “navigation nodes.” Navigation nodes may include all nodes that the strategy identifies that may be immediately reached from the current node. In other words, the navigation nodes represent potential direct successors from a current node. Another set of nodes is “start nodes.” Start nodes are potential starting points when entering a new graph. The more starting points this set contains, the more choices a learner has when entering the unit. As a consequence, any strategy should implement at least two functions that can compute these sets and the ordering function that transforms those sets into ordered lists. The functions are described in further detail below using the following examples.

In the following examples, these definitions are used:

C is the set of all courses.

G is a set of graphs.

V is a set of vertices (e.g., knowledge items, references to learning units, references to sub courses, and test) Vertices are used when talking about graphs in a mathematical sense (whereas nodes may used to refer to the resulting course structure)

E is a set of edges (e.g., relations types as used in a mathematical sense).

TG={sc, lu} is the set of graph types such that:

sc=sub-course; and

lu=learning unit.

TC={sc,lu,co,tst} is the set of content types such that:

sc=sub-course;

lu=learning unit;

co=content; and

tst=test.

(With respect to assigning competences to a learner when passing a test, only pretests and posttests are defined as tests; self-tests and exercises are content rather than tests.)

TK={ . . . } is the set of all knowledge types (e.g., as described in the section E-learning content structure).

TR={ . . . } is the set of all relation types(e.g., as described in the section E-learning content structure).

BOOL={true, false} is the Boolean set with the values true and false.

MAC={ . . . } is the set of macro-strategies (e.g., as described in the section E-learning strategies).

MIC={ . . . } is the set of micro-strategies (e.g., as described in the section E-learning strategies).

COMP={ . . . } is the set of all competences.

LCOMP⊂ COMP is the set of a learner's competences.

TST={pre,post} is the set of test types, such that:

pre=pretest; and

post=posttest.

A course c=(G_{c},gₛ,mac,mic)∈C may be defined such that:

G_{c} is the set of all sub-courses and learning units that are members of c;

gₛ is the start graph of course c, in particular gₛ∈G;

mac∈MAC is the macro-strategy that has been chosen for navigating the course; and

mic∈MIC is the micro-strategy that has been chosen for navigating the course.

Processing of the course begins with the start graph. A graph g=(V_{g},E_{g},t_{g},comp_{g})∈G may be defined such that:

V_{g} is the set of all vertices in g;

E_{g}⊂V_{g}×V_{g}TR is the set of all edges in g;

t_{g} ∈TG is the graph type of g; and

comp_{g}⊂COMP Are the competencies of the graph.

In the following description the term content graph is used to identify the sub-graph to which a vertex refers, rather than a graph that includes the vertex. One can think of the vertex representing the “placeholder” of the sub-graph. A vertex v=(vsᵥ,tcᵥ,gc_{c},tkᵥ,ttᵥmscoreᵥ,ascoreᵥ)∈V is defined such that:

vsᵥ∈BOOL is the visited status of v;

tcᵥ∈TC is the content type of v;

gcᵥ∈G is the content graph of v;

tkᵥ∈TK is the knowledge type of v;

ttᵥ∈TST is the test type of v;

mscoreᵥ is the maximum possible test score of v; and

ascoreᵥ is the test score actually attained for v.

An edge or relation type e=(v_{S},v_{E},trₑ)∈E may be defined such that:

v_{S}∈V is the starting vertex of e;

v_{E}∈V is the end vertex of e; and

trₑ∈TR is the relation type of e.

A predicate is a mapping p:V→BOOL that assigns a value bₚ∈BOOL to each vertex v∈V. Therefore:

bₚ=p(v).

An order is a mapping ord:V×V→BOOL that assigns a value b_{ord}∈BOOL to a pair of vertices v₁,v₂∈V. Therefore:

b_{ord}=ord(v₁,v₂).

The mapping sort:Vⁿ,ord→Vⁿ is a sorting function from a set of vertices Vⁿ to a set of vertices (v₁, . . . ,vₙ)=\overline{V}ⁿ with the order ord, provided that:

(v₁, . . . ,vₙ)=sort(Vⁿ,ord) such that

$${∀}_{i , j ∈ ( 1 n ) , i \neq j} {v}_{i} , {v}_{j} ∈ {V}^{n} : ord ( {v}_{i} , {v}_{j} ) = true$$

for i≦j.

The following description explains the use of attributes. Attributes are used to define and implement the learning strategies.

Let g=(V_{g},E_{g},t_{g},comp_{g})∈G be a graph with the following attributes:

g.nodes=V_{g} Are the vertices of g;

g.type=t_{g} is the type of g; and

g.comp=comp_{g} is the graph's competencies.

Let v=(vsᵥ,tcᵥ,gc_{c},tkᵥ,ttᵥ,mscoreᵥ,ascoreᵥ)∈V be a vertex with the following attributes:

v.visited=vsᵥ is the visited status of vertex v (initially this value is false);

v.graph={g=(V_{g},E_{g},t_{g})∈G|v∈V_{g}} is the graph that contains v;

v.contentType=tcᵥ is the content type of v;

$$v . contentGraph = \{ \begin{matrix}{g}^{′} ∈ G : {tc}_{v} = sc ⋁ {tc}_{v} = lu \\ undef : otherwise \end{matrix}$$

is the content graph of v;

v.knowType=tkᵥ is the knowledge type of v;

$$v . testType = \{ \begin{matrix}{tt}_{v} ∈ TST : {tc}_{v} = tst \\ undef : otherwise \end{matrix}$$

is the test type of v;

v.mscore=mscoreᵥ is the maximum possible test score of v (initially this value is 0);

v.ascore=ascoreᵥ is the actual test score attained for v (initially this value is −1

Let e=(v_{S},v_{E},trₑ)|E be an edge with the following attributes:

e.start=v_{S} is the starting vertex of e;

e.end=v_{E} is the end point of e;

e.type=trₑ is the relation type of e;

An edge's logical direction does not necessarily have to agree with the direction indicated by the course player, because the course player displays an edge in the “read direction.” This applies to the following edge, for example, e=(v_{S},v_{E},“is a subset of”). The following explanation refers to the logical direction, in other words, the direction of the edge in the above-described cases is considered to be “rotated.” In the following, undirected edges are treated as two edges in opposite directions.

Predicates are “dynamic attributes” of vertices. The strategy computes the dynamic attributes for an individual vertex when necessary.

The following are examples of predicates:

Visited(v): the vertex v has already been visited;

Suggested(v): the vertex v is suggested;

CanNavigate(v):the vertex v can be navigated; and

Done(v): the vertex v is done.

If a vertex is within a learning unit (i.e., v.graph.type=lu), then the micro-strategy is used to compute the predicates. The macro-strategy that is chosen is responsible for determining all other vertices.

Functions are used to compute the navigation sets (vertices that are displayed). A function should return a set of vertices. The strategies implement the functions.

For example, the following functions are:

\overline{V}=StartNodes(g)={\overline{v}|\overline{v} is a starting vertex of g} is the set of all starting vertices of graph g. Starting vertices are the vertices of a graph from which navigation within the graph may be initiated in accordance with a chosen strategy.

\overline{V}=NextNodes(v)={\overline{v}|\overline{v} is a successor of v} is the set of all successor vertices of vertex v.

For micro-strategies, the chosen macro-strategy calls the functions as needed. When entering a learning unit the macro-strategy selects the appropriate (selected) micro-strategy.

Operations provide information to the chosen strategy about particular events that occur during navigation of a course. The strategy may use them to change the attributes. The operations are:

navigate(v); The runtime environment calls this operation as soon as the vertex v is navigated during the navigation of the course.

testDone(v,MaxScore,ActScore); The runtime environment calls this operation if the vertex v is a test (v.contentType=tst) that has been done. MaxScore contains the maximum possible score, ActScore the score actually attained.

If a vertex is in a learning unit, which means that v.graph.type=lu, then the micro-strategy computes these operations. The macro-strategy is responsible for all other vertices.

The runtime environment uses the sorting function to order the navigation sets that have been computed. The order determines the sequence in which the vertices are to be drawn. The “most important” vertex (e.g., from the strategy's point of view) is placed at the start of the list (as the next vertex suggested). The strategies implement these sorting functions and the runtime environment provides them. The following examples of sorting functions may be defined:

sortNav(V) is used to sort the set of navigation vertices.

The sorting functions are called automatically as soon as the functions have returned sets of vertices to the strategy in question. It is consequently necessary that each macro and micro-strategy have a sorting function at its disposal.

The following description explains the predicates, operations, functions, and sorting functions associated with macro-strategies.

The following is an example of how a top-down (deductive) learning strategy may be realized.

The predicates for the top-down strategy may be defined as follows:

Visited(v):v.visited

The vertex's “visited” attribute is set.

Suggested(v):∀(\overline{v},v,tr)∈E such that tr=prerequisite we have:

Done(\overline{v})=true

All of the vertex's prerequisites are satisfied.

CanNavigate(v):Suggested(v)

Is used in this example like Suggested

Done(v):

(v.contentType∈{sc,lu}Λv.contentGraph.comp≠Ø⊂LCOMP)ν(v.contentType≠tstΛv.visited=true Λ(∀\overline{v}∈StartNodes(v.contentGraph):Done(\overline{v})=true))ν(v.contentType=tst Λ(v.ascore*2)≧v.mscore)

The vertex v is considered done if at least one of the following conditions holds:

It includes a learning unit or sub-course that has at its disposal a nonempty set of competences that the learner already possesses;

It does not contain a test, is visited, and all of the content graph's starting vertices have been done; and/or

It deals with a test and at least half of the maximum score has been attained.

The functions for the top-down strategy may be defined as follows:

$$StartNodes ( g ) = \{ \begin{matrix}g = undef : ∅ \\ g . type = lu : c . mic . StartNodes ( g ) \\ g . type = sc : \{ v ∈ {V}_{g} \vert ∀ ( {v}^{*} , v , tr ) ∈ E : tr \neq hierarchical \}\end{matrix}$$

If g is undefined, which means that vertex does not have any content graphs, then the set is empty.

If g is a learning unit, the StartNodes( ) function of the chosen micro-strategy will be used.

If g is a sub-course, all vertices that do not have any hierarchical relations referring to them will be returned.

NextNodes(v)={\overline{v}∈V_{v graph}|∃(v,\overline{v},tr)}∪StartNodes(v.contentGraph)

All vertices connected to v by an externally directed relation, plus all vertices that are starting vertices of the content graph of v.

The operations for top-down may be defined as follows:

navigate(v): v.visited=true

The vertex's “visited” attribute is set to true.

testDone(v,MaxScore,ActScore):v.mscore=MaxScore,v.ascore=ActScore if

$$\{ \begin{matrix}Done ( v ) = true : LCOMP = LCOMP ⋃ v . graph . comp , ∀ \overline{v} ∈ v . graph : \overline{v} . visited = true \\ Done ( v ) = false : ∀ \overline{v} ∈ v . graph : \overline{v} . visited = false \end{matrix}$$

The maximum test score and the test score actually attained for the vertex are both set.

If the test is passed, the learner competences will be enlarged to include the competences of the graph, and all of the graph's vertices will be set to “visited.”

If the test is not passed, all of the graph's vertices are reset to “not visited.”

The sorting function sortNav(V) may be defined upon an order relation <: V₁×V₂→bool on a set of vertices. This requires that the following auxiliary functions be defined:

1. An order relation for vertices with respect to the vertex ID

<_{id}:V×V→bool

v₁<_{id}v₂: [symbol] v₁.id<v₂.id

2. A comparison relation for vertices with respect to the vertex ID

=:V×V→bool,

v₁=v₂: [symbol] v₁.id=v₂.id

3. An order relation on the test types and unit types

<ₜₑₛₜ:(TC×TST)×(TC×TST)→bool

(tst,pre)<(co,undef)<(lu,undef)<(tst,post)

4. An order relation based on 3. for vertices with respect to the test types and unit types.

<ₜₑₛₜ: V×V→bool

v₁<ₜₑₛₜv₂: [symbol] (v₁.contentType, v₁.testType)<ₜₑₛₜ (v₂.contentType, v₂.testType)

5. A comparison relation for vertices with respect to the test types and unit types

=ₜₑₛₜ:V×V→bool

v₁=ₜₑₛₜ v₂: [symbol] (v₁.contentType, v₁.testType)=(v₂.contentType, v₂.testType)

6. An order relation on the knowledge types based on one of the micro-strategies (see micro-strategies)

<_{micro}:TK×TK→bool

7. An order relation based on 6. on the vertices with respect to the micro-strategies.

<_{micro}:V×V→bool

v₁<_{micro} v₂: [symbol] v₁.knowType<_{micro} v₂.knowType

8. A comparison relation to the vertices in regard to the knowledge types

=_{micro}: V×V→bool

v₁=_{micro} v₂: [symbol] v₁.knowType=v₂.knowType

Using these definitions the function <: V₁×V₂→bool may be defined as follows:

$${v}_{1} < {v}_{2} : ⇔ \{ \begin{matrix}{v}_{1} . contentType \neq tst ⋀ \\ ∃ v ∈ {V}_{1} : [ ( {v}_{1} , v , prereq ) ∈ {E}_{1} ⋀ v . contentType \neq tst ⋀ {v}_{1} < v ⋀ v \leq {v}_{2} ] \\ ⋁ {v}_{1} {<}_{test} {v}_{2} \\ ⋁ {v}_{1} {=}_{test} {v}_{2} ⋀ {v}_{1} {<}_{id} {v}_{2} if {g}_{1} = {g}_{2} , {t}_{1} \neq lu \\ {v}_{1} . contentType \neq tst ⋀ \\ ∃ v ∈ {V}_{1} : [ ( {v}_{1} , v , prereq ) ∈ {E}_{1} ⋀ v . contentType \neq tst ⋀ {v}_{1} < v ⋀ v \leq {v}_{2} ] \\ ⋁ {v}_{1} {<}_{test} {v}_{2} \\ ⋁ {v}_{1} {=}_{test} {v}_{2} ⋀ {v}_{1} {<}_{micro} {v}_{2} \\ ⋁ {v}_{1} {=}_{test} {v}_{2} ⋀ {v}_{1} {=}_{micro} {v}_{2} ⋀ {v}_{1} {<}_{id} {v}_{2} if {g}_{1} = {g}_{2} , {t}_{1} = lu \\ ∃ v = ( vs , {t}_{1} , {g}_{1} , tk , tt , ms , as ) ∈ {V}_{2} : ( v , {v}_{2} , tr ) ∈ {E}_{2} ⋀ tr ∈ \{ prereq , hierearchical if {g}_{1} \neq {g}_{2} , {t}_{1} = lu , {t}_{2} \neq lu \\ false otherwise\end{matrix}$$

Note, if g₁=g₂, then it is obvious that V₁=V₂, E₁=E₂, t₁=t₂ and comp₁=comp₂. In addition, in case 3, a situation is maintained in which no direct relation between the vertices exists, but there does exist a relation to the higher-order vertex. The order relation will then also apply to all of the vertices in this vertex's content graph. This situation is depicted in FIG. 28, where v is the vertex that represents the learning unit and v₁,v₂ are the vertices under consideration.

The function sortNav(V) is the sort of the set V in accordance with the order relation <.

The following process is one method of implementing the function sortNav(V):

1. V_{preTest}={v∈V|v.contentType=tstΛv.testType=pre}: the set of all pretests.

2. V=V−V_{preTest}: remove all pretests from V.

3. V_{postTest}={V|v.contentType=tstΛv.testType=post}: the set of all posttests.

4. V=V−V_{postTest}: remove all posttests from V.

5. V_{pre Req}={V∈V|∃(\overline{v},v,tr)∈E:tr=prerequisite}: the set of all vertices that have a prerequisite relation directed toward them.

6. V=V−V_{pre Req}: remove all vertices in V_{pre Req} from V.

7. L=V_{preTest}: add all pretests into the sorted list.

8. L=L∪{v∈V|v.contentType=co},V=V−L:enlarge the sorted list to include all vertices that have a learning unit and then remove these vertices from V.

9. L=L∪{v∈V|v.contentType=lu},V=V−L:enlarge the sorted list to include all vertices that contain a learning unit and then remove these vertices from V.

10. L=L∪V:enlarge the sorted list to include the remaining vertices from V.

11. Search for all vertices in v∈V_{pre Req}:

the vertex v*∈L such that

(v*,v,prerequisite)∈EΛdist(v*)=MAX (the vertex that is located farthest back in Land that possesses a prerequisite relation to v).

Add v into L behind v*.

12. L=L∪V_{postTest}: enlarge the sorted list to include all posttests.

13. Return the sorted list L as the result.

The subsets determined in steps 7-12 are themselves sorted by the order relation <_{id}.

The following is an example of how a bottom-up (Inductive) learning strategy may be implemented.

The predicates for this strategy may be the same as those used for the macro-strategy, top-down. The functions for bottom-up may be defined as follows:

$$StartNodes ( g ) = \{ \begin{matrix}g = undef : ∅ \\ g . type = lu : c . mic . StartNodes ( g ) \\ g . type = sc : \{ v ∈ {V}_{g} \vert ∀ ( {v}^{*} , v , tr ) ∈ E : tr \neq hierarchical \}\end{matrix}$$

If g is undefined, the vertex doesn't have a content graph and the set is empty.

If g is a learning unit, then the StartNodes( ) function of the chosen micro-strategy will be used.

If g is a sub-course, then all vertices that do not have any hierarchical relations referring to them will be returned.

NextNodes(v)={\overline{v}∈V_{v graph}|∃(\overline{v},v,tr)}∪

$$\{ \begin{matrix}v . contentType = le ⋀ ∃ ( v , {v}^{*} , tr ) ∈ E : tr = hierarchical ⋀ Done ( {v}^{*} ) = false : \\ OrientationOnly . StartNodes ( v . contentGraph ) \\ else : \\ StartNodes ( v . contentGraph )\end{matrix} \}$$

All vertices that are connected to v by an externally directed relation.

If the vertex contains a learning unit and one of the hierarchically subordinate vertices has not yet been visited, enlarge the set to include the learning unit's starting vertex using the micro-strategy “orientation only.” Otherwise, enlarge the set to include all vertices that are starting vertices of the content graph of v.

The operations and sorting function for the bottom-up strategy are the similar to the macro-strategy top-down and therefore are not repeated.

Linear macro-strategies represent a special case of the macro-strategies that have already been described. In linear macro-strategies, the elements of the sorted sets of vertices are offered for navigation sequentially, rather than simultaneously. This linearization may be applied to any combination of macro and micro-strategies.

The following description includes examples of how a micro-strategy may be realized. In this example, an orientation only micro-strategy is described.

The predicates for the micro-strategies may be defined as follows:

Visited (v):v.visited

The vertex's “visited” attribute is set.

Suggested(v):∀(\overline{v},v,tr)∈E such that tr=prerequisite we have:

Done(\overline{v})=true

All of the vertex's prerequisites are already satisfied.

CanNavigate(v):Suggested(v)

This may be used like Suggested.

Done(v):

(v.contentType≠tstΛv.visited=true)Λ(c.contentType=tstΛ(v.ascore*2)≧v.mscore)

The vertex v is considered done if:

It does not contain a test and has already been visited.

It deals with a test and at least half of the maximum score has been attained.

The functions may be defined as follows:

StartNodes(g)={v∈V_{g}|v.knowType=Orientation}∪{v∈V_{g}|∃(v,\overline{v},tr)∈E:tr=prereqΛ\overline{v}.knowType=Orientation}

The set of all vertices with knowledge type orientation, plus all vertices that have a prerequisite relation to a vertex with knowledge type orientation.

NextNodes(v)=Ø

For this micro-strategy, this is always the empty set. In other words, no successor vertices exist because all relevant vertices are contained in the set of starting vertices.

The operations may be defined as follows:

navigate(v):v.visited=true

The vertex's “visited” attribute is set to true.

testDone(v, MaxScore, ActScore):v.mscore=MaxScore, v.ascore=ActScore

if

$$\{ \begin{matrix}Done ( v ) = true : LCOMP = LCOMP ⋃ v . graph . comp , ∀ \overline{v} ∈ v . graph : \overline{v} . visited = true \\ Done ( v ) = false : ∀ \overline{v} ∈ v . graph : \overline{v} . visited = false \end{matrix}$$

The maximum test score and the test score actually attained for the vertex are both set.

If the test is passed, the learner competences will be enlarged to include the competences of the graph, and all of the graph's vertices will be set to “visited.”

If the test is not passed, all of the graph's vertices are reset to “not visited.”

The micro-strategy orientation only may use a sorting function that is similar to sorting function for the macro-strategy top-down and, therefore is not repeated.

The following is an example of the implementation of an example oriented micro-strategy. The predicates for this strategy are identical to those for the micro-strategy orientation only and are not repeated.

The functions may be defined as follows:

StartNodes(g)=V_{g}

All vertices that are contained in the learning unit.

NextNodes(v)=Ø

For this micro-strategy, this is always the empty set.

In other words, no successor vertices exist because all relevant vertices are contained in the set of starting vertices.

The operations for the example-oriented micro-strategy are identical to those for the micro-strategy “orientation only,” and, therefore, are not repeated.

The sorting function for example-oriented is defined as follows:

$${v}_{1} < {v}_{2} : ⇔ \{ \begin{matrix}{v}_{1} {<}_{test} {v}_{2} ⋁ \\ {v}_{1} {=}_{test} {v}_{2} ⋀ {v}_{1} {<}_{id} {v}_{2} if {v}_{2} . contentType = tst \\ ∃ ( {v}_{1} , {v}_{2} , tr ) ∈ E : tr = prereq ⋁ \\ ( {v}_{1} . knowType = Example ⋀ {v}_{1} {<}_{id} {v}_{2} ) if {v}_{2} . knowType = Example \\ {v}_{1} . knowType = Example ⋁ \\ {v}_{1} {>}_{id} {v}_{2} otherwise\end{matrix}$$

Steps for executing sortNav(V):

1. Vₑₓₐₘₚ{v∈V|v.knowType=Example}∪{v∈V|∃(v,\overline{v},tr)∈E:tr=prereqΛv.knowType=Example}: the set of all vertices that contain examples, plus the prerequisites of these vertices.

2. Vᵣₑₘₐᵢₙ=V−Vₑₓₐₘₚ: the remaining vertices from V.

3. Lₑₓₐₘₚ=TopDown.sortNav(Vₑₓₐₘₚ): sort the set of examples using the sorting algorithm from the top-down strategy.

4. Lᵣₑₘₐᵢₙ=TopDown.sortNav(Vᵣₑₘₐᵢₙ): sort the set of remaining vertices using the sorting algorithm from the top-down strategy.

5. L=Lₑₓₐₘₚ∪Lᵣₑₘₐᵢₙ: form the union of the two sorted lists.

6. Return the sorted list L as the result.

The predicates, functions, and operations for the micro-strategy explanation-oriented are identical to those for the micro-strategy example-oriented, and, therefore are not repeated. The sorting function for the explanation-oriented micro-strategy is similar to the sorting function of the micro-strategy example-oriented (the only difference being that explanations, rather than examples, are used to form the two sets).

The predicates, functions, and operations for the micro-strategy action-oriented are identical to those for the micro-strategy example-oriented, and, therefore are not repeated. The sorting function for the action-oriented micro-strategy is similar to the sorting function of the micro-strategy example-oriented (the only difference being that actions, rather than examples, are used to form the two sets).

A number of implementations have been described. Nevertheless, it will be understood that various modifications may be made. For example, advantageous results may be achieved if the steps of the disclosed techniques are performed in a different order and/or if components in a disclosed system, architecture, device, or circuit are combined in a different manner and/or replaced or supplemented by other components. Accordingly, other implementations are within the scope of the following claims.

What is claimed is:

1. A learning system comprising:
a learning station to take a course and select a learning strategy;
a content management system to store the course including content and structure;
a learning management system to determine learning content to present to the learning station based on the selected learning strategy; and
a communications link to transfer the content from the learning management system to the learning station.

2. The system of claim 1 wherein the course includes one or more structural elements including one or more of a course, a sub-course, a learning unit, and a knowledge item.

3. The learning system of claim 2 wherein the learning management system includes a content player configured to apply the selected learning strategy to the structural elements to determine a navigation path to be transmitted to the learning station.

4. The learning system of claim 3 wherein the course and its structural elements do not enforce a sequence of structural elements that a learner must use to traverse the course.

5. The learning system of claim 3 wherein the content player is configured to interpret metadata associated with the structural elements.

6. The learning system of claim 5 wherein the metadata includes attributes including one of a knowledge type and a competency.

7. The learning system of claim 3 wherein the content player is configured to interpret relations between structural elements.

8. The learning system of claim 7 wherein the relations are directional.

9. The learning system of claim 1 further comprising a learning administration system configured to store course information, wherein the learning station includes a learning interface configured to present the course information.

10. The learning system of claim 9 wherein the course information includes a learner account.

11. The learning system of claim 10 wherein the learner account includes one or more of training activities, course prebookings, a notebook, a qualifications profile, a profile matchup, a preferred learning strategy.

12. The learning system of claim 10 wherein the learner account includes training activities of courses that have been booked to the learner account.

13. The learning system of claim 10 wherein the learner account includes course prebookings for courses desired by a learner but not offered by the learning system.

14. The learning system of claim 10 wherein the learner account includes a notebook to store one or more of learner qualifications, subject areas, courses, and course dates.

15. The learning system of claim 10 wherein the learner account includes a qualifications profile that includes any qualifications that should be obtained by a learner.

16. The learning system of claim 10 wherein the learner account includes a qualifications profile that includes any qualifications obtained by a learner.

17. The learning system of claim 10 wherein the learner account includes a profile matchup to compare qualifications of a learner against a qualification profile.

18. The learning system of claim 10 wherein the learner account includes a preferred learning strategy to be applied by the learning management system to course structure to determine a navigation path for the content associated with the course.

19. The learning system of claim 9 wherein the learning interface includes a messages and notes window to provide a learner with messages and notes from the learning administration system.

20. The learning system of claim 19 wherein the window includes one or more of mandatory courses a learner should take and qualifications the learner should obtain.

21. The learning system of claim 9 wherein the learning interface includes a current training activities window listing all courses booked by a learner.

22. The learning system of claim 9 wherein the learning interface includes a navigation window to access a course catalog listing all course published to the administration management system.

23. The learning system of claim 22 wherein the learning interface includes a navigation window to access a search function to search for courses in the course catalog.

24. The learning system of claim 9 wherein the learning interface includes a navigation window to access a learner account.

25. The learning system of claim 22 wherein the learner account includes one or more of training activities, course prebookings, a notebook, a qualifications profile, a profile matchup, a preferred learning strategy.

26. The learning system of claim 1 wherein the learning station includes a learning interface configured to present course content to a learner.

27. The learning system of claim 26 wherein the learning interface includes a navigation bar to navigate through a course presented by the learning station.

28. The learning system of claim 27 wherein the navigation bar includes one or more of the functions back, continue, table of contents, and path.

29. The learning system of claim 26 wherein the learning interface includes a table of contents

30. The learning system of claim 26 wherein the learning interface includes a navigation path window to display a navigation path to a learner.

31. The learning system of claim 30 wherein the content management system includes a content player and the content player is configured to apply a learning strategy selected by a learner to content to determine the navigation path.

32. The learning system of claim 31 wherein the learning strategy is a macro-strategy.

33. The learning system of claim 32, wherein the macro-strategy includes applying one of a goal-based, top-down strategy, a goal-based, bottom-up strategy and a table of contents strategy.

34. The learning system of claim 31 wherein the learning strategy is a micro-strategy.

35. The learning system of claim 34 wherein the micro-strategy includes applying one of an orientation only strategy, an action oriented strategy, an explanation oriented strategy, an orientation oriented strategy, and a table of contents strategy.

36. A learning station comprising:
an input to select a learning strategy and a course;
a communications interface to transfer data between a learning management system and the learning station; and
a processor to present a course based on the transferred data and the selected learning strategy.

37. The station of claim 33 wherein the course includes one or more structural elements including one or more of a course, a sub-course, a learning unit, and a knowledge item.

38. The learning station of claim 37 wherein data received from the learning management system includes a navigation path determined from applying the selected learning strategy to the structural elements.

39. The learning station of claim 38 wherein the course and its structural elements do not enforce a sequence of structural elements that a learner must use to traverse the course.

40. The learning station of claim 38 wherein the navigation path is determined based on metadata associated with the structural elements.

41. The learning station of claim 40 wherein the metadata includes attributes including one of a knowledge type and a competency.

42. The learning station of claim 38 wherein the navigation path is based on relations between structural elements.

43. The learning station of claim 42 wherein the relations are directional.

44. The learning station of claim 36 further comprising a learning interface configured to present the course information.

45. The learning station of claim 44 wherein the course information includes a learner account.

46. The learning station of claim 45 wherein the learner account includes one or more of training activities, course prebookings, a notebook, a qualifications profile, a profile matchup, a preferred learning strategy.

47. The learning station of claim 45 wherein the learner account includes training activities of courses that have been booked to the learner account.

48. The learning station of claim 45 wherein the learner account includes course prebookings for courses desired by a learner but not offered by the learning system.

49. The learning station of claim 45 wherein the learner account includes a notebook to store one or more of learner qualifications, subject areas, courses, and course dates.

50. The learning station of claim 45 wherein the learner account includes a qualifications profile that includes any qualifications that should be obtained by a learner.

51. The learning station of claim 45 wherein the learner account includes a qualifications profile that includes any qualifications obtained by a learner.

52. The learning station of claim 45 wherein the learner account includes a profile matchup to compare qualifications of a learner against a qualification profile.

53. The learning station of claim 45 wherein the learner account includes the selected learning strategy to be applied by the learning management system to course structure to determine a navigation path for the content associated with the course.

54. The learning station of claim 44 wherein the learning interface is configured to present a messages and notes window to provide a learner with messages and notes from a learning administration system.

55. The learning station of claim 54 wherein the window includes one or more of mandatory courses a learner should take and qualifications the learner should obtain.

56. The learning station of claim 44 wherein the learning interface is configured to present a current training activities window listing all courses booked by a learner.

57. The learning station of claim 44 wherein the learning interface is configured to present a navigation window to access a course catalog listing all course published to the administration management system.

58. The learning station of claim 57 wherein the learning interface is configured to present a navigation window to access a search function to search for courses in the course catalog.

59. The learning station of claim 44 wherein the learning interface is configured to present a navigation window to access a learner account.

60. The learning station of claim 57 wherein the learner account includes one or more of training activities, course prebookings, a notebook, a qualifications profile, a profile matchup, a preferred learning strategy.

61. The learning station of claim 36 wherein the learning station includes a learning interface configured to present course content to a learner.

62. The learning station of claim 61 wherein the learning interface is configured to present a navigation bar to navigate through a course presented by the learning station.

63. The learning station of claim 62 wherein the navigation bar includes one or more of the functions back, continue, table of contents, and path.

64. The learning station of claim 61 wherein the learning interface includes a table of contents.

65. The learning station of claim 61 wherein the learning interface is configured to present a navigation path window to display a navigation path to a learner.

66. The learning station of claim 65 wherein navigation path is determined from the selected learning strategy.

67. The learning station of claim 66 wherein the learning strategy is a macro-strategy.

68. The learning station of claim 67, wherein the macro-strategy includes applying one of a goal-based, top-down strategy, a goal-based, bottom-up strategy and a table of contents strategy.

69. The learning station of claim 66 wherein the learning strategy is a micro-strategy.

70. The learning station of claim 69 wherein the micro-strategy includes applying one of an orientation only strategy, an action oriented strategy, an explanation oriented strategy, an orientation oriented strategy, and a table of contents strategy.
